(19) United States
(12) Patent Application Publication
(10) Pub. No.: US 2017/0061438 A1
(43) Pub. Date: Mar. 2, 2017

(54) SECURITY ENHANCEMENT SYSTEM, METHOD AND DEVICE FOR INSTRUMENT-BASED TRANSACTIONS

(71) Applicant: Ashish R. Patel, Williamsville, NY (US)

(72) Inventor: Ashish R. Patel, Williamsville, NY (US)

(21) Appl. No.: 15/192,527

(22) Filed: Jun. 24, 2016

Related U.S. Application Data
(60) Provisional application No. 62/303,584, filed on Mar. 4, 2016.
(60) Provisional application No. 62/271,534, filed on Dec. 28, 2015.
(60) Provisional application No. 62/212,284, filed on Aug. 31, 2015.

(51) Int. Cl. G06Q 20/40; G06T 5/50; G06K 9/00; G06Q 40/02; G06K 9/18

(52) U.S. Cl. CPC G06Q 20/4016; G06Q 40/02; G06K 9/186; G06K 9/00288; G06T 5/50; G06K 9/00442; G06T 2207/20221; G06T 2207/30201

(57) ABSTRACT

A security enhancement system, method and device are disclosed herein. The system, method and device, in an embodiment, are operable to establish an account for a user to receive a request associated with a financial instrument. The system, method and device are operable to apply one or more approval conditions before providing an approval to a funding source.

### CROSS-REFERENCE TO RELATED APPLICATIONS

This application is a non-provisional of, and claims the benefit and priority of, the following: (i) U.S. Patent Application No. 62/303,584 filed on Mar. 4, 2016; (ii) U.S. Patent Application No. 62/271,534 filed on Dec. 28, 2015; and (iii) U.S. Patent Application No. 62/212,284 filed on Aug. 31, 2015. The entire contents of such applications are hereby incorporated by reference.

### BACKGROUND

Fraudulent transactions are the cause of major loss to the financial industry each year. The losses affect banks as well as check-cashing companies, sometimes referred to as money service businesses. In an attempt to cope with the losses, banks and check-cashing companies increase their service charges to customers, or they withhold certain services from their customers altogether. Consequently, the customers, banks and check-cashing companies bear the burden of the fraud.

The known verification steps for check transactions, for example, include the verification of basic, personal information and the review of basic check data. These measures fail to provide adequate fraud detection. This is due, in part, to the increased savvy of wrongdoers and the increased sophistication of the electronic tools available to wrongdoers. The risk and frequency of fraud is particularly high with respect to electronic transactions in which the customer might wish to transmit electronic images of paper checks for depositing or cashing.

The foregoing background describes some, but not necessarily all, of the problems, disadvantages and challenges related to electronic transactions.

### SUMMARY

The subject matter disclosed herein includes, in an embodiment, a system having a data storage device configured to be operatively coupled to a network. The data storage device stores a plurality of computer-readable instructions which are executable by at least one processor to: (a) establish a user account associated with a user; (b) receive a request from a first network access device operatively coupled to the network, wherein the request relates to a financial instrument possessed by the user; (c) require submission of a first image representing a front of the financial instrument, wherein the front image displays a monetary amount; (d) require submission of a second image representing a back of the financial instrument, wherein the back image displays an indorsement by the user; (e) require submission of a third image representing biometric information related to the user; and (f) receive data associated with the first, second and third images.

Also, the instructions are executable by the processor to generate a fourth image having: (a) a combination the third image and the second image; or (b) a combination of the third image and the first image. Furthermore, the instructions are executable by the processor to: (a) enable the request and the fourth image to be accessed by a device, wherein the device includes the processor or a second network access device operatively coupled to the network; (b) receive a response from the device; and (c) depending upon the response, provide an approval notice to a fund source.

In another embodiment, the system includes a data storage device configured to be operatively coupled to a network, wherein the data storage device stores a plurality of computer-readable instructions which are executable by at least one processor to: (a) establish a user account associated with a user; (b) operatively couple the user account to a financial account of the user in response to a first input from a first network access device which is operatively coupled to the network; (c) receive a request from the first network access device, wherein the request is associated with a financial instrument, and wherein the financial instrument has a front and a back, and the front shows a gross amount and an identity of the user; (d) receive a front image which represents the front, wherein the front image is generated by the first network access device; (e) receive a back image which represents the back, wherein the back image is generated by the first network access device, wherein the back image is generated by the first network access device; (f) receive a biometric image which represents a physical characteristic of the user, wherein the biometric image is generated by the first network access device; (g) generate a collective image including the back image and the biometric image; (h) enable a second network access device to access the front and collective images, wherein the second network access device is operatively coupled to the network; (i) receive a response from the second network access device, wherein the response comprises a decline of the request or an approval of the request; (j) if the decline is received, provide a decline notice to the first network access device; and (k) if the approval is received, provide an approval notice to a fund source, wherein the fund source is operable to transfer a net amount to the financial account, wherein the net amount is based, at least in part, on the gross amount.

In yet another embodiment, the subject matter disclosed herein includes a method of securing instrument-based transactions. The method includes; (a) operating at least one processor which is operatively coupled to a data network, wherein the processor is operable to control a system; (b) enabling a user to access the system using a first network access device; (c) operating the processor to establish a user account for the user; (d) operating the processor to operatively couple the user account to a financial account controlled by the user; (e) operating the processor to receive a request from the first network access device to credit the financial account based on a financial instrument possessed by the user, wherein the financial instrument has a physical form; and (f) operating the processor to send a first notice displayable by the first network access device, wherein the first notice is related to a first requirement requiring the first network access device to send instrument data to the at least one processor.

The instrument data comprises: (a) a front image of a front of the financial instrument, wherein the front image displays an identity of the user and an amount payable; (b) a back image of a back of the financial instrument, wherein the back image displays an indorsement by the user; and (c) a biometric image derived from a human body of the user.

The method also includes: (a) operating the processor to enable a second network access device to access the instrument data; (b) operating the processor to receive a first evaluation result from the second network access device, wherein the first evaluation result is based on a first evaluation of the instrument data; (c) depending upon the first evaluation result, operating the processor to provide an approval notice displayable by the first network access device; (d) operating the processor to provide a second notice to the first network access device, wherein the second notice relates to a second requirement, wherein the second requirement requires the first network access device to send voiding evidence to the at least one processor, wherein the voiding evidence comprises an image of a void indicator which is visible on at least one of the front and back sides of the physical form of the financial instrument; (e) operating the processor to enable the second network access device to access the voiding evidence; (f) operating the processor to receive a second evaluation result, wherein the second evaluation result is based on a second evaluation of the voiding evidence; and (g) depending upon the second evaluation, operating the processor to provide an approval notice to a fund source.

In still another embodiment, the subject matter disclosed herein includes an instrument voiding device and a personal action device. In an embodiment, the instrument voiding device is configured to be part of or otherwise operate in conjunction with the systems described above. The personal action device, in an embodiment, is operable to facilitate personal activities and can be used in conjunction with or apart from the systems described above.

Additional features and advantages of the present disclosure are described in, and will be apparent from, the following Brief Description of the Drawings and Detailed Description.

### BRIEF DESCRIPTION OF THE DRAWINGS

FIG. 1 is a schematic diagram illustrating the relationships between the different types of accounts related to an embodiment of the security enhancement system.

FIG. 2 is a top view of the front and the back of an example of an embodiment of an un-indorsed, unmodified financial instrument in physical form and in image form.

FIG. 3 is a schematic, flow diagram illustrating the component relationships and logic of an embodiment of the security enhancement system.

FIG. 4 is a schematic, flow diagram illustrating an example of an operation of an embodiment of the security enhancement system.

FIG. 5 is a front view of an example of the biometric, facial image of an embodiment of the security enhancement system.

FIG. 6 is a top view of the front and the back of an example of the embodiment of the financial instrument of FIG. 2 after it has been indorsed and modified to include the biometric, facial image and date and time stamp.

FIG. 7 is a schematic, flow diagram illustrating the continuation of the example of the operation in FIG. 4.

FIG. 8 is a top view of the front and the back of an example of the embodiment of the financial instrument of FIG. 6 after it has been voided through physical alteration.

FIG. 9 is a top view of an embodiment of the grid implemented by the security enhancement system to optically analyze the front of the financial instrument of FIG. 8 to confirm the presence of one or more pass-through, voiding openings.

FIG. 10 is a top view of an embodiment of the grid implemented by the security enhancement system to optically analyze the back of the financial instrument of FIG. 8 to confirm the presence of one or more pass-through, voiding openings.

FIG. 11 is a schematic, flow diagram illustrating the component relationships and logic of an embodiment of the fund availability system.

FIG. 12 is a schematic, flow diagram illustrating an example of an operation of an embodiment of the fund availability system.

FIG. 13 is a top view of an example of a login interface of an embodiment of the fund availability system.

FIG. 14 is a top view of examples of a setup or setting interface and an informational interface of an embodiment of the fund availability system.

FIG. 15 is a top view of an example of an instrument capture or instrument submission interface of an embodiment of the fund availability system.

FIG. 16 is a top view of the front and the back of an example of an embodiment of an un-indorsed, unmodified financial instrument in physical form and in image form intended for use with an embodiment of the fund availability system.

FIG. 17 is a top view of an example of a populated version of the instrument capture or instrument submission interface of FIG. 15.

FIG. 18 is a top view of an example of a request confirmation interface of an embodiment of the fund availability system, confirming that the user's request has been transmitted to a financial service provider.

FIG. 19 is a top view of the front and the back of an example of the embodiment of the financial instrument of FIG. 16 after it has been indorsed, marked with an approval code and voided through physical alteration.

FIG. 20 is a top view of a guarantee stamp of an example of an embodiment of the fund availability system.

FIG. 21 is top view of the front and the back of an example of the embodiment of the financial instrument of FIG. 19 after it has been digitally, electronically or graphically modified to incorporate the user's biometric image and guarantee stamp of FIG. 20.

FIG. 22 is a top view of an example of a fund method selection interface of an embodiment of the fund availability system, enabling the user to select from a plurality of optional fund methods.

FIG. 23 is a top view of an example of an account activity interface of an embodiment of the fund availability system.

FIG. 24 is a top view of an example of a notification interface of an embodiment of the fund availability system.

FIG. 25 is a top, isometric view of embodiment of an instrument voiding device.

FIG. 26 is a side elevation view of the instrument voiding device of FIG. 25.

FIG. 27 is a top view of examples of embodiments of punch and die shapes of the instrument voiding device of FIG. 25.

FIG. 28 is schematic view of an embodiment of the controller of the instrument voiding device of FIG. 25.

FIG. 29 is a top view of an example of the physical form of a financial instrument, illustrating a plurality of voiding punch holes passing through the front and back of the financial instrument, formed though use of the instrument voiding device of FIG. 25.

FIG. 30 is a top, isometric view of another embodiment of an instrument voiding device.

FIG. 31 is a bottom, isometric view of the embodiment of the instrument voiding device of FIG. 30.

FIG. 32 is a cross-sectional view of the embodiment of the instrument voiding device of FIG. 30, taken substantially along line A-A of FIG. 31.

FIG. 33 is an isometric, fragmentary view of the embodiment of the instrument voiding device of FIG. 30, illustrating the interior of the portion or half including an arm.

FIG. 34 is a top isometric view of an embodiment of a personal action device.

FIG. 35 is a schematic diagram illustrating the communication of the personal action device of FIG. 34 with a plurality of different devices, including a computer, smartphone, payment receiver and door lock module.

### DETAILED DESCRIPTION

### 1. Instrument-Based Transactions

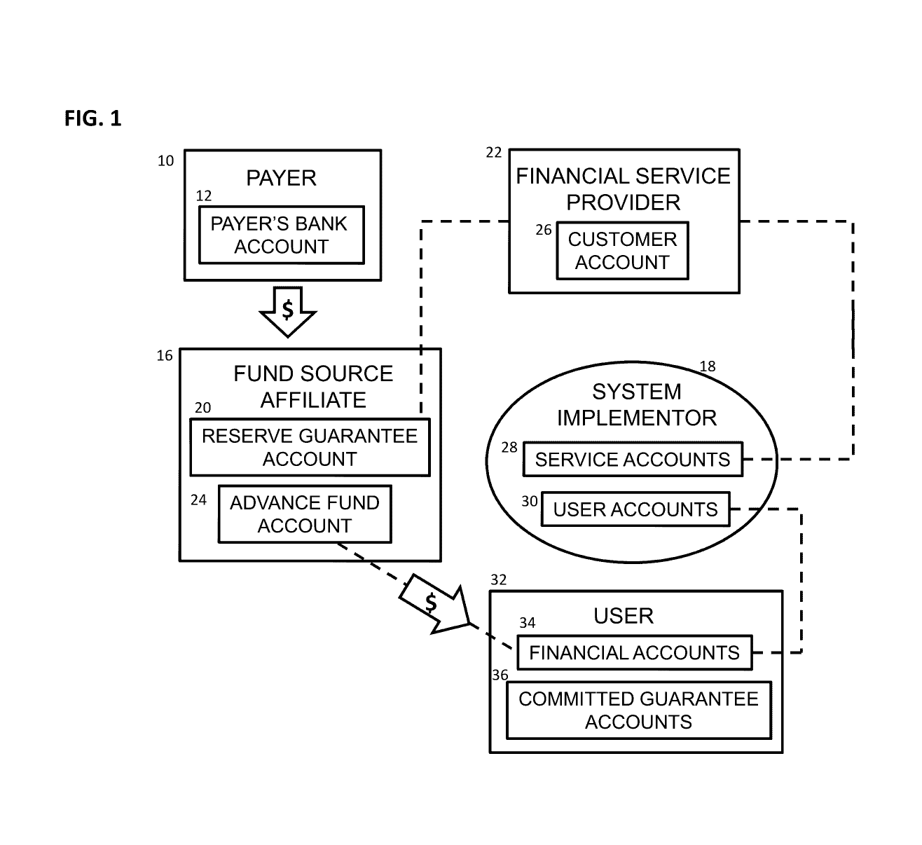

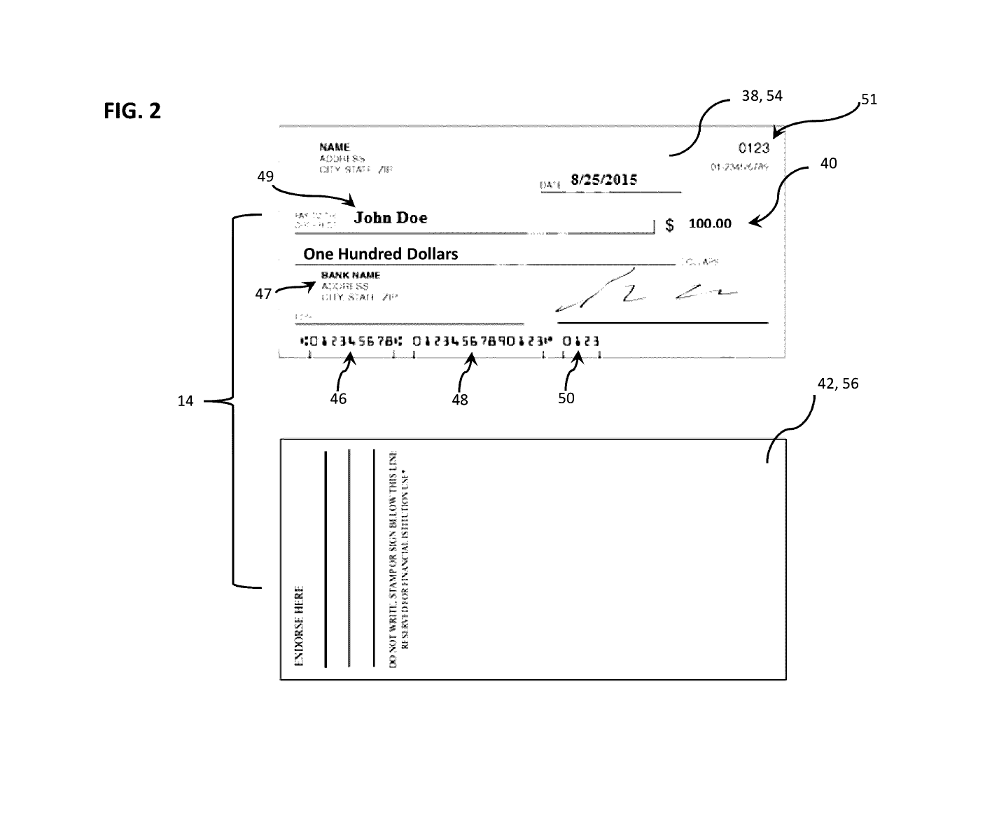

In an embodiment, the subject matter described herein relates to technical systems, methods and devices involving financial instruments used in financial transactions. Depending upon the embodiment, there are a plurality of different types of accounts involving or related to such financial transactions. As illustrated in FIG. 1, a payer 10 owns or controls the payer's bank account 12. The payer 10 authorizes the drawing of funds from the payer's bank account 12 in accordance with a financial instrument or instrument 14 (FIG. 2). After the financial instrument 14 is cleared, the payer's bank transfers funds to the fund source affiliate 16, an affiliate or contractor of the system implementor 18.

The fund source affiliate 16, in an embodiment, is a bank, financial sponsor or other fund source affiliated with the system implementor 18. The found source affiliate 16 controls a reserve guarantee account 20 established and maintained by a financial service provider 22. Also, the found source affiliate 16 owns and controls an advance fund account 24.

In an embodiment, the financial service provider 22 is a cheek cashing entity, check casher or bank. The financial service provider 22 serves its customers and establishes a customer account 26 for each of its customers.

The system implementor 18 establishes and controls a service account 28 for each of its clients. The clients of the system implementor 18 include each financial service provider 22 whom has subscribed to the services of the system implementor 18. In addition, the system implementor 18 establishes and controls a user account 30 for each one of the users 32 of the systems operated by the system implementor 18.

Each user 32 owns one or more financial accounts 34. Depending upon the embodiment, the fund source affiliate 16, at the request of a financial service provider 22, may open and service any of the financial accounts 34 for a user 32. Alternatively, the user 32 can use a separate bank or entity of the user's preference to open and service any of the financial accounts 34. Depending upon the embodiment, a financial account 34 includes any monetary repository, bucket or pool owned or controlled by a user 32, including, but not limited to, a reloadable payment card issued by a bank or other funder (sometimes referred to as a prepaid card), a debit card, a bank account, a checking account, a savings account, a money market account, a cash account, an electronic wallet, an electronic purse, a PayPal® account, a Google® Wallet account, an Apple Pay® account or any other suitable online, wireless or Internet-accessible financial account for holding money or digital currency. In addition to the financial accounts 34, each user 32 may optionally own one or more committed guarantee accounts 36 as described further below.

In operation of an embodiment, a payer 10 opens a bank account 12, and a user 32 opens a customer account 26. The financial service provider 22 opens a service account 28 with the system implementor 18. In doing so, the financial service provider 22 opens a reserve guarantee account 20 and transfers a threshold amount of funds into such reserve guarantee account 20. Next, the payer 10 provides the user 32 (in this case, also a payee) with an instrument 14 (FIG. 2) in physical form. The user 32 processes the instrument 14 using the user account 30 as described below. In an embodiment, depending upon the option selected by the user 32, the fund source affiliate 16 advances funds from the advance fund account 24 to a designated financial account 34 of the user 32. In one example, the found source affiliate 16 performs this transfer before the fund source affiliate 16 clears the instrument 14 with the bank of the payer 10. If, during the subsequent clearing process, the fund source affiliate 16 finds that the payer's bank account 12 has insufficient funds for the instrument 14, the fund source affiliate 16 seeks recovery by first drawing funds from the one or more financial accounts 34 of the user 32. If those funds are inadequate for the full recovery, the fund source affiliate 16 then draws funds from the reserve guarantee account 20.

As described further below, the user 32 may also act as a guarantor instead of a payee. For example, the user 32 may link his/her user account 30 to a committed guarantee account 36 owned by the user 32, such as a bank account or credit card (e.g., Visa® or MasterCard®). In one example, the user 32 can use his/her committed guarantee account 36 to guarantee or financially back an instrument-based transaction requested by the user 32. For example, a freelance journalist may receive a $50 check from a publishing company. To cash such check electronically, the financial service provider 22 can require the journalist to guarantee the sufficiency of the payer's funds. The user 32 can then authorize the financial service provider 22 or fund source affiliate 16 to charge his/her MasterCard® up to $50 if the payer 10 has insufficient funds.

In another example, the user 32 may assist another user 32, such as a friend, family member, colleague or someone within his/he social network. When the assisted user 32 seeks to cash an instrument 14, the assisting user 32 may guarantee the payment pursuant to the instrument 14 by authorizing the fund source affiliate 16 or financial service provider 22 to draw funds from the assisting user's committed guarantee account 36 in the case of an insufficient funds event.

In instrument-based transactions, the payer 10 (also known as a drawer) prepares the financial instrument 14, authorizing the drawing of a monetary amount from a drawee, such as the bank of the payer 10. In an embodiment, the financial instrument or instrument 14 includes, but is not limited to, a draft, a bond, a negotiable instrument and a cheek. It should be appreciated that the instrument 14 has a plurality of mediums or forms, including, but not limited to: (a) a physical form constructed of a sheet or layer of paper, polymeric material or any other suitable material; and (b) a virtual or electronic form which is graphically representable or displayable by a display device, monitor or screen, such as an image in a JPG, TIF, PNG, GIF or other suitable image format.

The payer 10 can mail or personally deliver the physical form of the instrument 14 to a payee (e.g., an employee, contractor, retail store or merchant). Though payers and payees may be described herein using the pronouns, he/she, it should be appreciated that a payer and a payee can each include any entity, including, but not limited, to a person, business, corporation, company, partnership, enterprise or other organization. After receiving the physical form of the instrument 14, the user 32 (acting as a payee) may desire to perform an electronic or image-based cashing or depositing of the instrument 14.

In an embodiment illustrated in FIG. 2, the physical front 38 of the physical form of the instrument 14 states the monetary gross amount 40 which is payable to the payee. In the example shown, the gross amount 40 is $100.00. As shown, the physical back 42 has not yet been indorsed or signed. As illustrated, the instrument 14 has abstracted data, which includes a routing number 46, account number 48 and check number 50. When the physical form of the instrument 14 is digitally photographed, scanned or imaged, the virtual or electronic form of the instrument 14 includes a front image 54 and a back image 56.

If the payee uses a bank customer account 26 as his/her financial account 34, the payee can deposit the instrument 14 into such bank customer account 26 and withdraw the monetary net amount after the instrument 14 clears. If the payee does not have a bank customer account or does not have ready-access to his/her bank, the payee can use another financial account 34 which is associated with a check casher customer account 26 of a check-cashing company or check casher.

In each such transaction, whether the financial service provider 22 is a bank or a check casher, there is the potential for fraud. For example, there is risk that the payee stole the instrument 14 and is not the proper party intended to receive the instrument 14. In remote, electronic transactions with banks, there is risk that the payee is wrongfully attempting to deposit the same instrument 14 more than once. Furthermore, the risk of fraud discourages or inhibits check cashers from allowing payees to perform remote, electronic check cashing transactions. This compels these payees to make inconvenient, in-person visits to brick-and-mortar check casher facilities.

The subject matter described herein enables the payee, acting as a user 32, to perform electronic or image-based cashing or depositing of the instrument 14 with a reduced risk of fraud, enhanced security and enhanced convenience. As described further below, the subject matter described herein increased the security of in-person transactions, and the subject matter also increases the security of remote and electronic transactions. Also, the subject matter described herein facilitates the accessibility of funds based on instrument transactions involving check cashers. As described further below, the subject matter described herein facilitates access to funds for in-person transactions and remote transactions. Further, the subject matter described herein includes instrument voiding devices operable to facilitate the voiding of instruments 14 involved in remote, electronic or image-based transactions.

### 2. Security Enhancement System

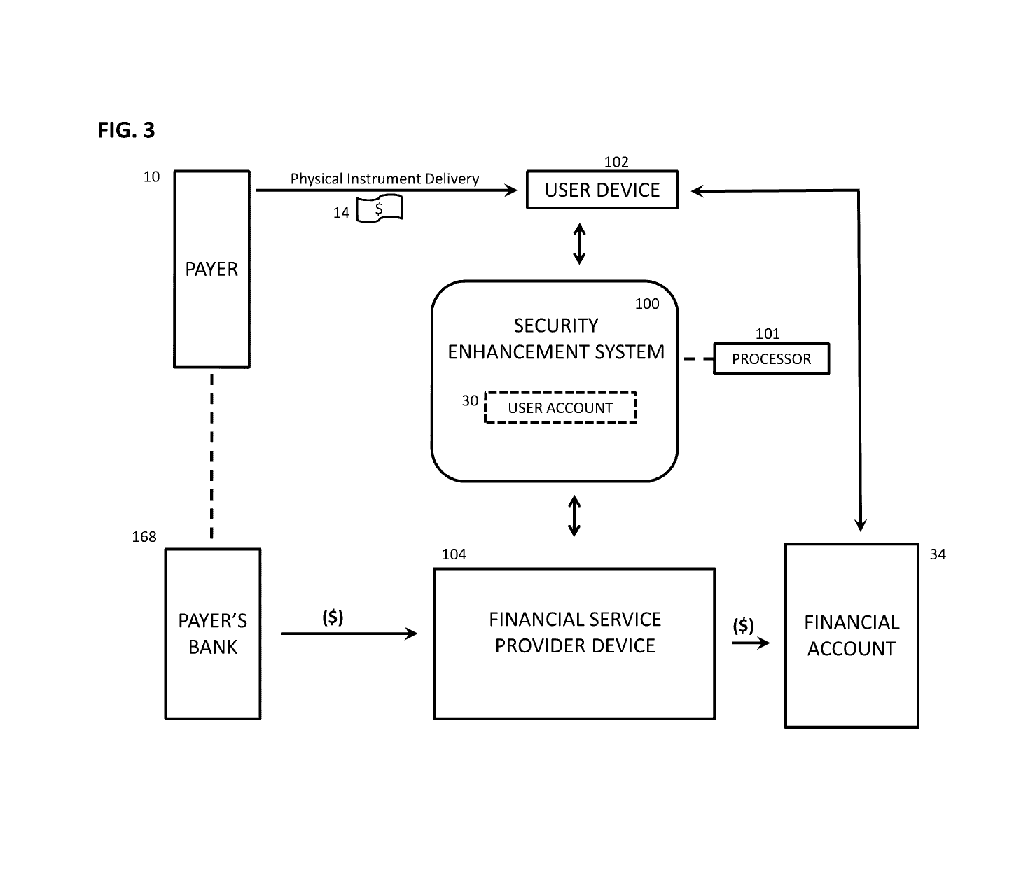

In an embodiment illustrated in FIG. 3, the security enhancement system 100 includes a data storage device storing computer-readable instructions, and the security enhancement system 100 is accessible by at least one processor 101 which operates according to the instructions. The security enhancement system 100 operates on a data network, such as the Internet. In an embodiment, the system implementor 18 (FIG. 1) operates, maintains and manages the security enhancement system 100. Accordingly, the security enhancement system 100 is accessible by: (a) a user device 102 operated by a payee or other user 32 (FIG. 1); and (b) a financial service provider device operated by a financial service provider 22 (FIG. 1). Depending upon the embodiment, the user device 102 and the financial service provider device each include a mobile communication device (e.g., smartphone or tablet), computer, laptop, kiosk, automated teller machine (ATM), terminal, server or any other suitable network access device.

The security enhancement system 100 is operable to increase the security of instrument-based transactions in or related to the financial industry. For example, in remote, electronic transactions, such as mobile banking, the security enhancement system 100 helps banks reduce the amount of instances in which the same instruments 14 are deposited more than once. The security enhancement system 100 also enables check cashers to securely offer or facilitate remote, electronic check cashing services to unbanked or underbanked users 32, including users 32 who lack bank accounts or who lack ready-access to their bank accounts. Accordingly, the security enhancement system 100 assists financial service providers 22 with directly or indirectly crediting or transferring funds to the financial accounts 34 of service providers' customers, who are users 34 acting as payees.

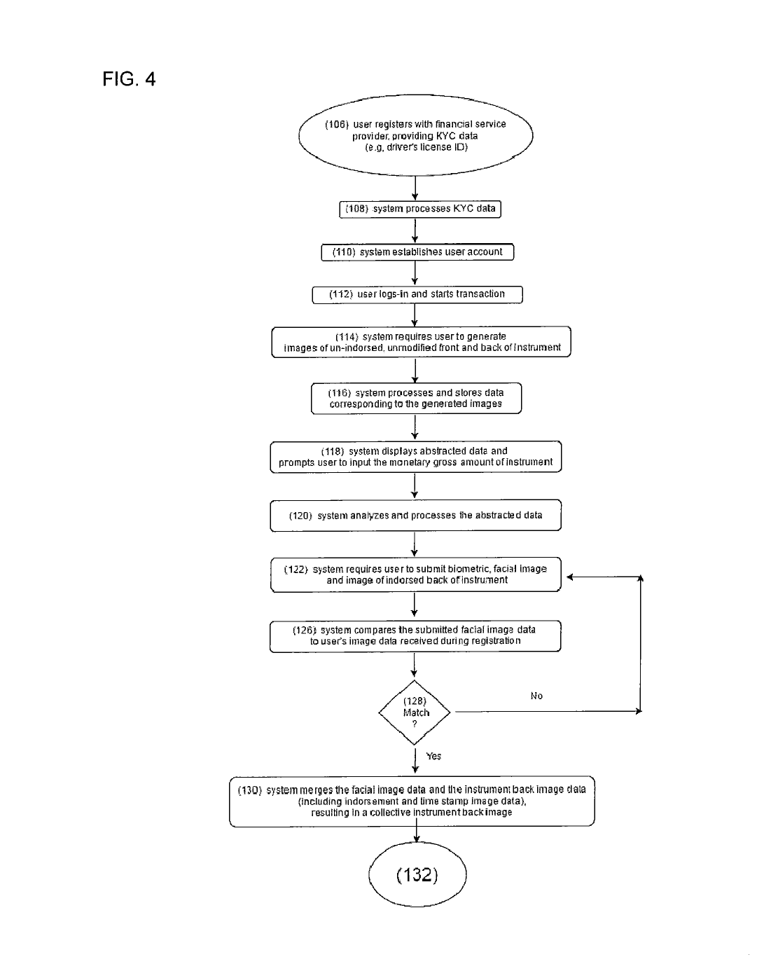

Referring to FIGS. 3-10, in an embodiment, the user 32 enrolls or registers with the security enhancement system 100, for example, when opening a customer account 26 with a financial service provider 22, as illustrated by block 106 in FIG. 4. In the registration process, the user 32 submits his/her personal identification documents (e.g., driver's license card or passport book), biometrics and other personally-identifiable information known as Know Your Customer (KYC) data. Depending upon the embodiment, biometrics include any information or data derived fully or partially from the human body of a person, including, but not limited to, fingerprints, thumbprints, voiceprints, voice audio outputs, retina scans, facial image (e.g., electronic photo or image of the face), DNA code or an image representing a DNA sample or DNA code.

This registration process can take place in-person or remotely. The user 32 can use the user device 12 to perform the registration. For example, the user 32 can remotely register using his/her mobile user device 102 while at home or elsewhere away from the brick-and-mortar facility of the financial service provider 22. Alternatively, the user 32 can visit a brick-and-mortar facility of the financial service provider 22 to perform the registration. It should be appreciated that the user 32 can also perform part of this registration process remotely and the other part of the registration process by visiting the brick-and-mortar facility of his/her financial service provider 22.

As illustrated by block 108 in FIG. 4, when the user 32 is ready to initiate an instrument-based transaction for an instrument 14, the security enhancement system 100 processes the KYC data to confirm the user's identity. In an embodiment, the security enhancement system 100 includes facial recognition computer code which the processor 101 executes to complete such identity confirmation. It should be appreciated, however, that in some embodiments, the security enhancement system 100 includes other types of identity verification software, including, but not limited to, biometric recognition computer code.

If the identity is confirmed, the security enhancement system 100 establishes and activates a user account 30 for the user 32, as illustrated by block 110. The security enhancement system 100 enables the user 32 to link or couple one or more desired financial accounts 34 to his/her user account 30. For example, the user 32 may link to his/her user account 30, his/her ewallet account, prepaid payment card account and PayPal® account.

Next, as illustrated by block 112 in FIG. 4, the security enhancement system 100 enables the user 32 to login to, and initiate, a session of the security enhancement system 100 to start the imaging process for the requested transaction. In an embodiment, the security enhancement system 100 enables Remote Check Capture (RCC), Remote Deposit Capture (RDC) and remote check image deposits for live, real time, instant or quick fund availability through the user's use of a user device 102.

The security enhancement system 100 includes a first security test or condition for evaluating whether the instrument 14 has been previously cashed or deposited. For the first security test or condition illustrated by block 114, the security enhancement system 100 prompts and requires the user 32 to generate or capture photographed, electronic images of: (a) the unmodified physical front 38 of instrument 14, resulting in front image 54 (FIG. 2); and (b) the unmodified, un-indorsed (e.g., unsigned) physical back 42 of instrument 14, resulting in back image 56 (FIG. 2). In an embodiment, the user 32 uses his/her user device 102 to digitally photograph the physical form of the instrument 14 (e.g., paper check), which, in turn, generates such images 54, 56. This first security test or condition prevents or inhibits the unlawful or fraudulent reuse of the same instrument 14 for multiple transactions. For example, the indorsement-free back image 56 is evidence that the instrument 14 has not been previously cashed, deposited or used. If the user 32 fails to pass the first security test or condition by providing the images 54, 56, the security enhancement system 100 or the financial service provider 22 can terminate or decline the user's request for the transaction.

As illustrated by block 116 in FIG. 4, the security enhancement system 100 analyzes, processes and stores the data extracted from the images 54, 56. Next, as illustrated by block 118, the security enhancement system 100 displays the abstracted data, which includes the routing number 46, account number 48 and check number 50, and the security enhancement system 100 prompts the user 32 to electronically input the exact monetary gross amount 40 stated on physical front 38 of the instrument 14.

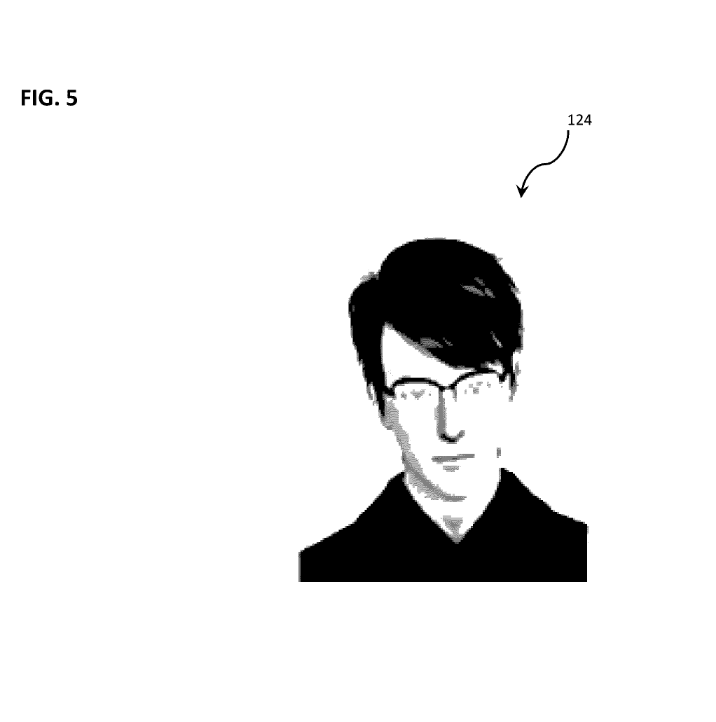

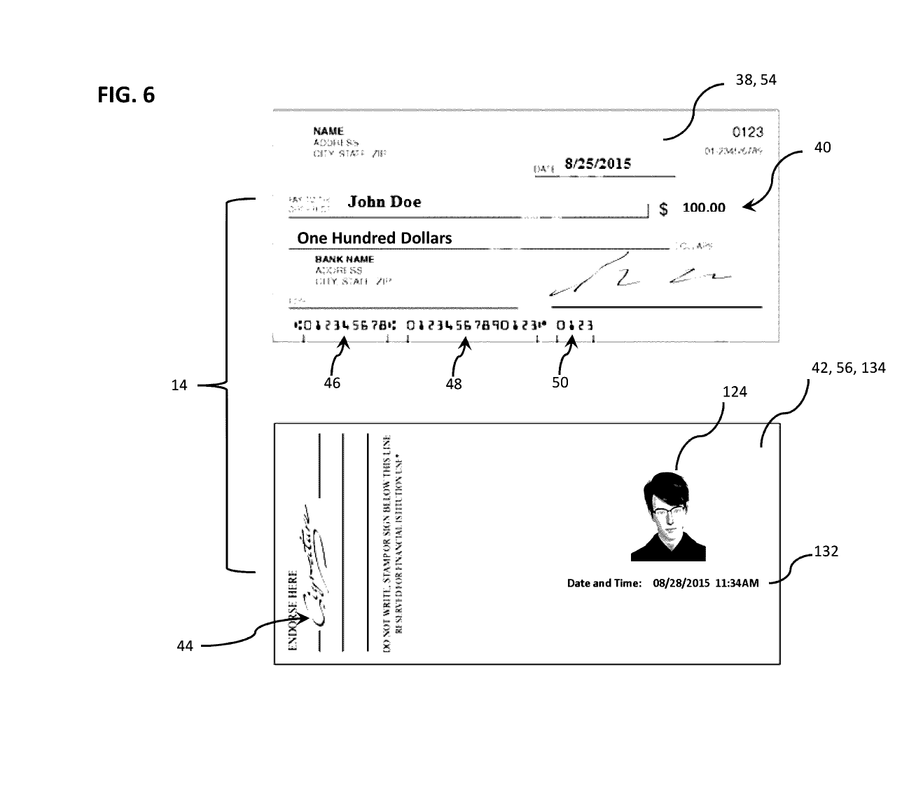

Next, as illustrated by block 120, the security enhancement system 100 processes such abstracted data 46, 48, 50. Then, as illustrated by block 122, the security enhancement system 100 prompts and requires the user 32 to: (a) submit his/her biometric, facial image 124 (FIG. 5), as illustrated by block 122; (b) sign or indorse the back 42 of the instrument 14; and (c) submit the indorsed back image 123 having indorsement 44 (FIG. 6). Using the camera of the user device 12, the user 32 can generate the facial image 124 and indorsed back image 123.

Next, the security enhancement system 100 performs a second security test or condition for evaluating whether the facial image 124 is authentic. In the second security test or condition illustrated by block 126 in FIG. 2, the security enhancement system 100 checks for a match, as illustrated by diamond 128, by analyzing the data corresponding to facial image 124 and comparing it to the data of the user's photograph retrieved during the registration process of block 106. For example, the security enhancement system 100 can automatically or semi-automatically compare the graphical, digital or binary data of the facial image 124 to the graphical, digital or binary data of the photograph of the user's driver's license or passport. The financial service provider 22 can use the facial image 124 to validate that the user 32 is the same person who is attempting to cash or deposit the instrument 14.

If the security enhancement system 100 or financial service provider 22 finds a successful match passing the second security test or condition, the security enhancement system 100 performs the following steps as illustrated by block 130: (a) embeds or digitally or graphically merges the facial image 124 into the indorsed back image 123 (which includes the indorsement image 44); (b) generates a date and time stamp image 132 (FIG. 6); and (c) embeds or digitally or graphically merges such data and time stamp image 132 into the indorsed back image 123 (FIG. 2). This results in the aggregate or collective instrument back image 134 illustrated in FIG. 6. If the user 32 fails to pass the second security test or condition due to a mismatch, the security enhancement system 100 or the financial service provider 22 can terminate or decline the user's request for the transaction.

In an embodiment, the data and time stamp image 132 corresponds to a time-sensitivity property of the instrument 14. For example, the security enhancement system 100 specifies a designated time period, such as thirty minutes, ten minutes or five minutes. The clock of the security enhancement system 100 automatically starts at the time displayed in the time stamp image 132. If the user's request to cash or deposit the instrument 14 is not approved within such designated time period, the security enhancement system 100 declines the request and requires the user 32 to initiate a new request.

In the example illustrated in FIG. 6, the collective instrument back image 134 includes a single static image (e.g., an image having format PG, TIF, PNG or GIF) which incorporates the indorsement image 44, facial image 124 and time stamp image 132. In an embodiment, the security enhancement system 100 performs such merger by graphically combining the separate images of the instrument back 56, indorsement image 44, facial image 124 and time stamp image 132. In another embodiment, the security enhancement system 100 performs such merger by combining the separate sets of digital or binary code corresponding to the different images 56, 44, 124 and 132 into a single, collective set of digital or binary code. The security enhancement system 100 executes the collective digital or binary code to generate the collective instrument back image 134.

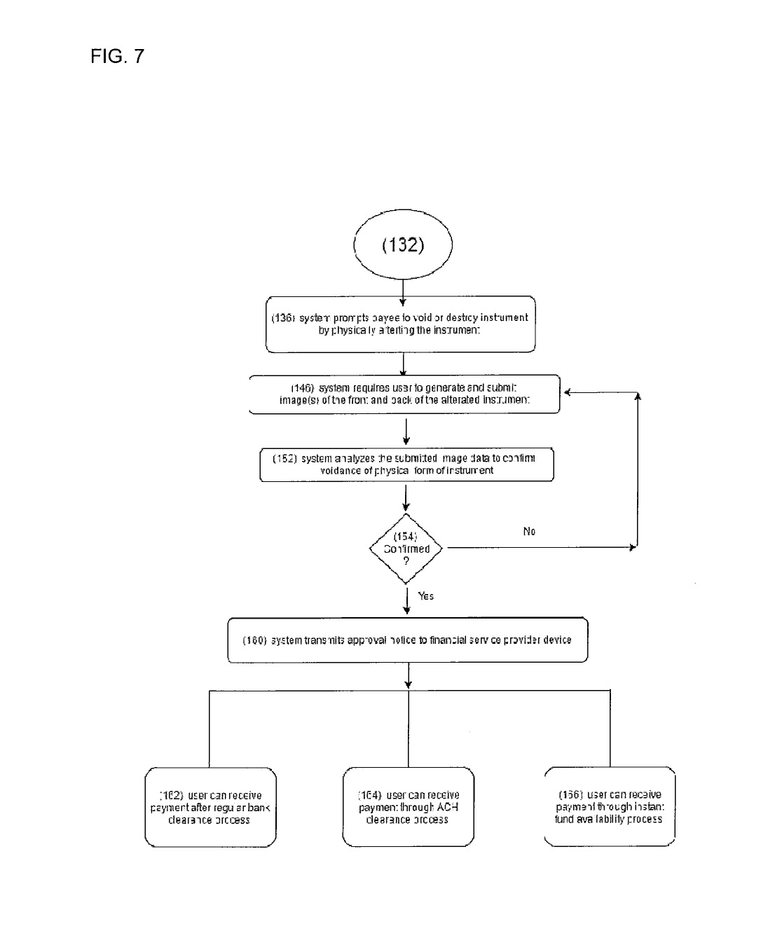

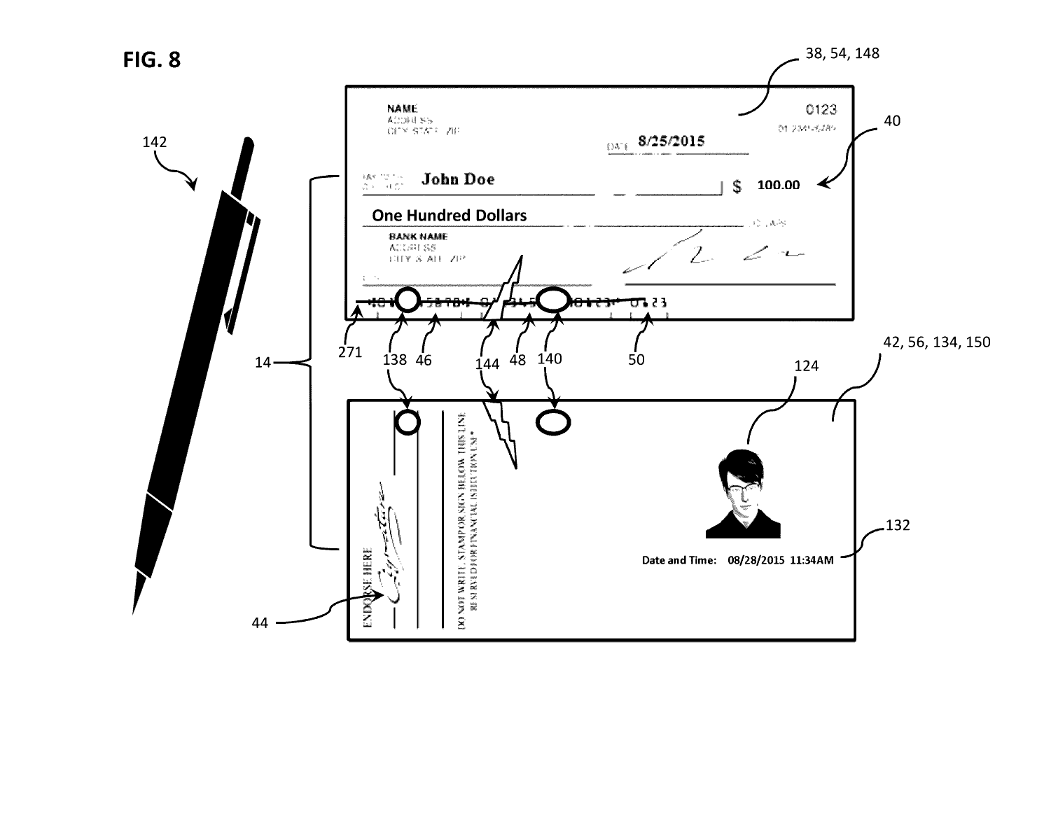

Next, the security enhancement system 100 performs a third security test or condition for evaluating whether the user 32 has voided the instrument 14. In the third security test or condition illustrated by block 136 in FIG. 7, the security enhancement system 100 requires and prompts the user 32 to destroy or void the physical form of instrument 14 by physically altering it. Referring to FIG. 8, depending upon the embodiment, the security enhancement system 100 instructs and requires the user 32 to physically alter the instrument 14 by: (a) poking or punching one or more holes, such as holes 138 and 140, by piercing the instrument 14 using a sharp object, such as a pen 142; (b) marking the physical front 38 or physical back 42 of the physical form of the instrument 14 with a pen 142 or other type of marking instrument, such as, by writing “VOID” on the physical front 38 or by drawing a line 271 through one or more of the number sets 46, 48, 50; (c) fully or partially tearing the physical form of the instrument 14, forming a tear gap 144; (d) altering or modifying the physical form of the instrument 14 in other suitable fashions; or (e) performing any suitable combination of the foregoing modification or alteration steps.

In proceeding with the third security test or condition illustrated by block 146 in FIG. 7, the security enhancement system 100 then requires the user 132 to generate or record a photo of the altered, voided front 38 and the altered, voided back 42 of the instrument 14, resulting in void front image 148 and void back image 150, as illustrated in FIG. 8. The security enhancement system 100 analyzes the void front and back images 148, 150 to confirm whether the instrument 14 has been physically destroyed or otherwise physically altered for voiding purposes, as illustrated by block 152 in FIG. 7. This prevents or inhibits the unlawful or fraudulent reuse of the same instrument 14 for multiple transactions. Effectively, this voiding requirement removes used instruments 14 from circulation to reduce fraud. If the security enhancement system 100 denies confirmation of voiding, as illustrated by diamond 154, the user 32 fails the third security test or condition. As a result, the security enhancement system 100 or financial service provider 22 prompts and requires the user 32 to re-submit front and back images of the voided or altered instrument 14.

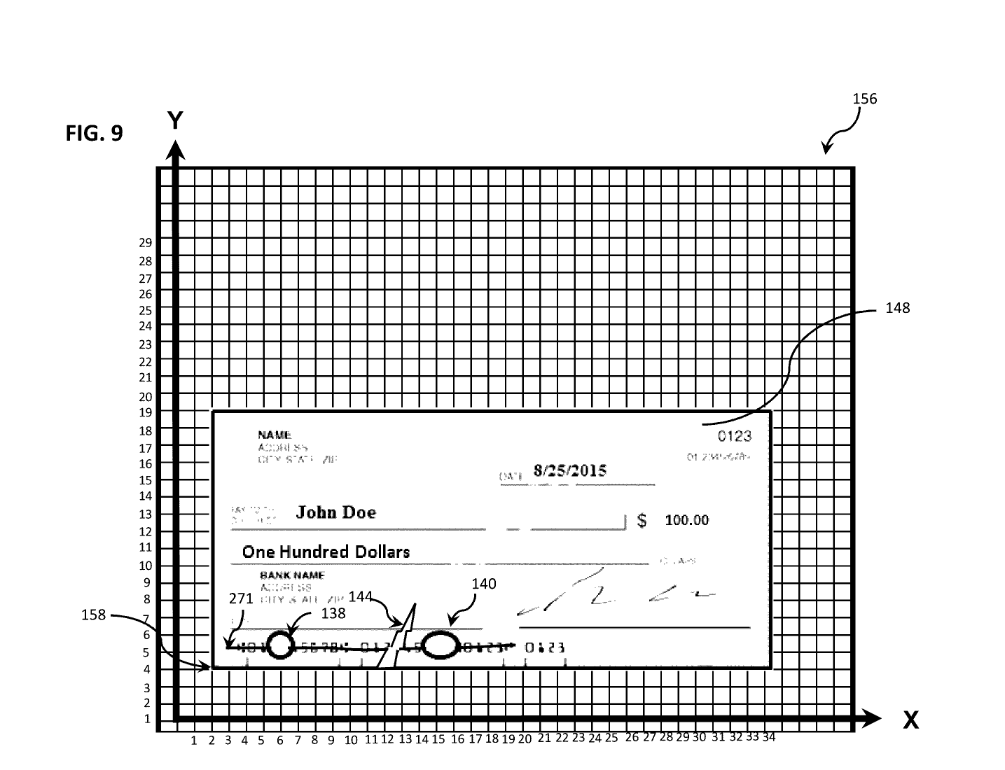

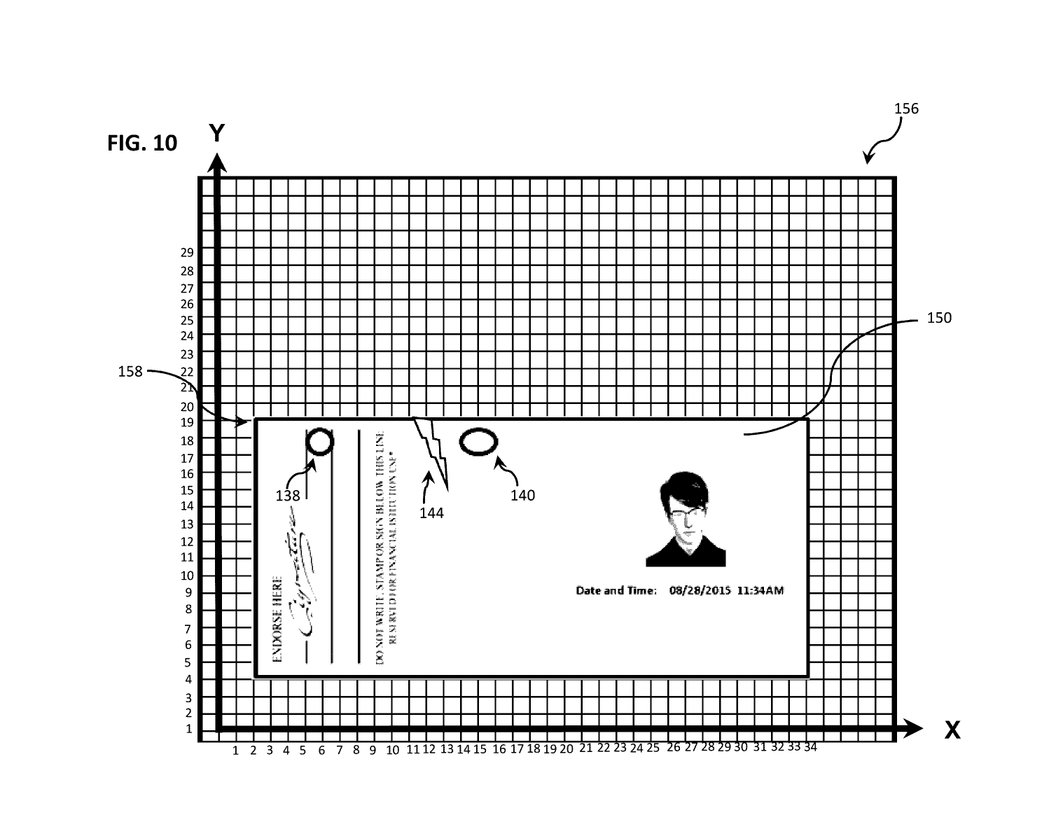

In an embodiment illustrated in FIGS. 9-10, the security enhancement system 100 performs a scanning or detection process to determine whether the user 32 has passed the third security test or condition. In one example, the security enhancement system 100 stores data corresponding to a grid 156 having X and Y axes, as shown. In the example shown in FIG. 9, the security enhancement system 100 plots the front image 148 on the grid 156 so that corner 158 is located at coordinate (2, 4). Starting at, or with reference to, coordinate 2 on the X axis, the security enhancement system 100 scans or inspects the front image 148. Depending upon the embodiment, the inspection involves an edge detection operation sweeping from left to right or a single shot image capture operation. In this example, during the inspection, the security enhancement system 100 determines that: (a) hole 138 has a far left edge at X coordinate 5.2 and a far right edge at X coordinate 6.8, resulting in a width of 1.6; (b) hole 138 has a lowermost edge at Y coordinate 4.7 and an uppermost edge at Y coordinate 6, resulting in a height of 1.3; (c) hole 140 has a far left edge at X coordinate 14.1 and a far right edge at X coordinate 16.2, resulting in a width of 2.1; (d) hole 140 has a lowermost edge at Y coordinate 4.7 and an uppermost edge at Y coordinate 6.1, resulting in a height of 1.4; (c) tear gap 144 has a far left edge at X coordinate 11.5 and a far right edge at X coordinate 13.5, resulting in a width of 2; and (d) tear gap 144 has a lowermost edge at Y coordinate 4 and an uppermost edge at Y coordinate 8, resulting in a height of 4. The security enhancement system 100 stores this edge coordinate data, width data and height data resulting from the inspection of the front image 148.

Next, as illustrated in FIG. 10, the security enhancement system 100 inspects the collective back image 150 to confirm whether the holes 138, 140 and tear gap 144 actually physically pass through the physical form of the instrument 14. Continuing with the example shown in FIG. 9, the security enhancement system 100 plots the collective back image 150 on the grid 156 so that corner 158 is located at coordinate (2, 19). Depending upon the embodiment, the inspection involves an edge detection operation sweeping from left to right or a single shot image capture operation. In this example, during the inspection the security enhancement system 100 determines that: (a) hole 138 has a far left edge at X coordinate 5.2 and a far right edge at X coordinate 6.8, resulting in a width of 1.6; (b) hole 138 has a lowermost edge at Y coordinate 17.2 and an uppermost edge at Y coordinate 18.5, resulting in a height of 1.3; (c) hole 140 has a far left edge at X coordinate 14.1 and a far right edge at X coordinate 16.2, resulting in a width of 2.1; (d) hole 140 has a lowermost edge at Y coordinate 17.2 and an uppermost edge at Y coordinate 18.6, resulting in a height of 1.4; (c) tear gap 144 has a far left edge at X coordinate 11.5 and a far right edge at X coordinate 13.5, resulting in a width of 2; and (d) tear gap 144 has a lowermost edge at Y coordinate 15 and an uppermost edge at Y coordinate 19, resulting in a height of 4. The security enhancement system 100 stores this edge coordinate data, width data and height data resulting from the inspection of the collective back image 150.

In this example, the security enhancement system 100 automatically recognizes that: (a) the far left X coordinates of the holes 138, 144 and tear gap 144 of the front image 148 match the far left X coordinates of the holes 138, 144 and tear gap 144 of the collective back image 150; (b) the far right X coordinates of the holes 138, 144 and tear gap 144 of the front image 148 match the far right X coordinates of the holes 138, 144 and tear gap 144 of the collective back image 150; (c) the widths of the holes 138, 144 and tear gap 144 of the front image 148 match the widths of holes 138, 144 and tear gap 144, respectively, of the collective back image 150; and (d) the heights of the holes 138, 144 and tear gap 144 of the front image 148 match the heights of the holes 138, 144 and tear gap 144, respectively, of the collective back image 150. Based on this recognition, the security enhancement system 100 confirms that the physical form of the instrument 14 (e.g., paper check) has been fully pierced or torn for voiding purposes so that one or more openings pass entirely through the physical form of the instrument 14.

If the user 32 fails the third security test or condition because the security enhancement system 100 does not confirm that the instrument 14 has been voided, the security enhancement system 100 requires the payee to submit an additional set of images to prove instrument voiding, as indicated by diamond 154 in FIG. 7. Alternatively, in the case of such test failure, the security enhancement system 100 or financial service provider 22 terminates or denies the user's request to cash or deposit the instrument 14.

Referring to FIG. 7, as illustrated by block 160, when the security enhancement system 100 successfully confirms that the instrument 14 has been voided, the third security test or condition has been passed, and the security enhancement system 100 transmits an approval notice to the financial service provider device 104. In an embodiment, the security enhancement system 100 also transmits to the financial service provider device 104, the front image 54 (FIG. 6) and the collective instrument back image 134 (FIG. 6). Depending upon the internal procedures of the financial service provider 22, the security enhancement system 100 also transmits to the financial service provider device 104, the void-indicated, front image 148 (FIG. 8) and the void-indicated, collective back image 150 (FIG. 8). In an embodiment, the security enhancement system 100 also transmits to the financial service provider device 104, the data corresponding to the instrument 14 in a text file or other suitable format, including the complete MICR data having the routing, account and check numbers 46, 48 and 50, respectively.

Next, the security enhancement system 100 is operable to automatically or semi-automatically trigger: (a) a regular bank clearance process as illustrated by block 162; (b) an Automated Clearance House (ACH) clearance process as illustrated by block 164; or (c) an instant fund transfer process as illustrated by block 166. In the regular bank clearance process, the user 32 waits for the fund source affiliate 16 (FIG. 1) to clear the instrument 14 during a regular or standard bank clearance period, such as two to three business days. In such clearance process, the payer's bank 168 (FIG. 3) confirms the availability of funds for the instrument 14, and the payer's bank 168 then transfers the monetary gross amount 40 to the fund source affiliate 16. After receiving such gross amount 40, the fund source affiliate 16 transfers a net amount to the user's financial account 34. In this example, the net amount is equal to the gross amount 40 received from the payer's bank 168 less service fees retained by the fund source affiliate 16, the financial service provider 22, the system implementor 18 or any suitable combination of such entities. The user 32 may then withdraw the net amount from the user's financial account 34, or the user 32 may use the net amount for purchases.

In the ACH clearance process, indicated by block 164 in FIG. 7, the security enhancement system 100 electronically cooperates and communicates with an Automated Clearing House (ACH) database. In this example, the fund source affiliate 16 electronically communicates with the ACH database. Based on such communication with the ACH database, the fund source affiliate 16 promptly clears the instrument 14 in a relatively short ACH period, such as a twenty-four hour period or less. Shortly after or upon such clearance, the fund source affiliate 16 electronically transfers a net amount to the user's financial account 34. In this example, the net amount is equal to the gross amount 40 received from the payer's bank 168 less service fees retained by the fund source affiliate 16, the financial service provider 22, the system implementor 18 or any suitable combination of such entities. The user 32 may then withdraw the net amount from the user's financial account 34, or the user 32 may use the net amount for purchases.

In the instant or quick fund transfer process, indicated by block 166 in FIG. 7, the user 32 has elected to use his/her check casher as the financial service provider 22. In doing so, the user 32 may cash instrument 14 in-person at the brick-and-mortar facility of the check casher, or the user 32 may use his/her check casher to receive a credit in his/her financial account 32. In each such scenario, the check casher instructs its fund source affiliate 16 to transfer a net amount to the user's financial account 34 without waiting for the instrument 14 to be cleared by the payer's bank 168 (FIG. 3). In this example, the net amount is equal to the gross amount 40 received from the payer's bank 168 less service fees retained by the fund source affiliate 16, the financial service provider 22, the system implementor 18 or any suitable combination of such entities.

In the in-person scenario, the check casher representative hands physical cash to the user 32, or the check casher representative electronically transfers the net amount to the user's financial account 34. In the remote scenario, the check casher's fund source affiliate 16 (or the electronic device of such affiliate) electronically transfers the net amount to the user's financial account 34. This transfer of the net amount occurs instantly or relatively quickly. For example, such transfer occurs within ten minutes, within five minutes, within one minute, within ten seconds or within one second after the security enhancement system 100 transmits the approval notice to fund source affiliate 16 or to a network access device of the fund source affiliate 16. The user 32 may then instantly or immediately withdraw the net amount from the user's financial account 34, or the user 32 may instantly or immediately use the net amount for purchases.

In another embodiment of the instant fund transfer process, a bank replaces the role of the check casher described above. This may be useful for bank account holders who have low bank account balances but wish to receive instant or quick loading of their financial accounts 34.

As described above, the security enhancement system 100 assists financial service providers 22 with directly or indirectly crediting or transferring funds to the financial accounts 34 of the service providers' customers, who are users 34 acting as payees. Accordingly, financial service providers 22, such as check cashing entities, can eliminate or reduce the burden to carry cash at their brick-and-mortar facilities. This reduces risks related to theft and misappropriation of cash.

### 3. Fund Availability System

3.1 Logic

In an embodiment illustrated in FIGS. 1, 3 and 11, the fund availability system 200 enables financial service providers 22 to remotely perform or effectuate instrument-based transactions with enhanced security and speed. In an embodiment, the fund availability system 200 includes and incorporates all of the structure, logic, steps, functionality and elements of the security enhancement system 100 described above. In addition, the fund availability system 200 includes guarantee functionality to expedite the transfer of funds to the user's financial account 34. As described further below, the fund source affiliate 16 instantly or quickly transfers funds to the user's financial account 34 with decreased risks of insufficient funds and fraud.

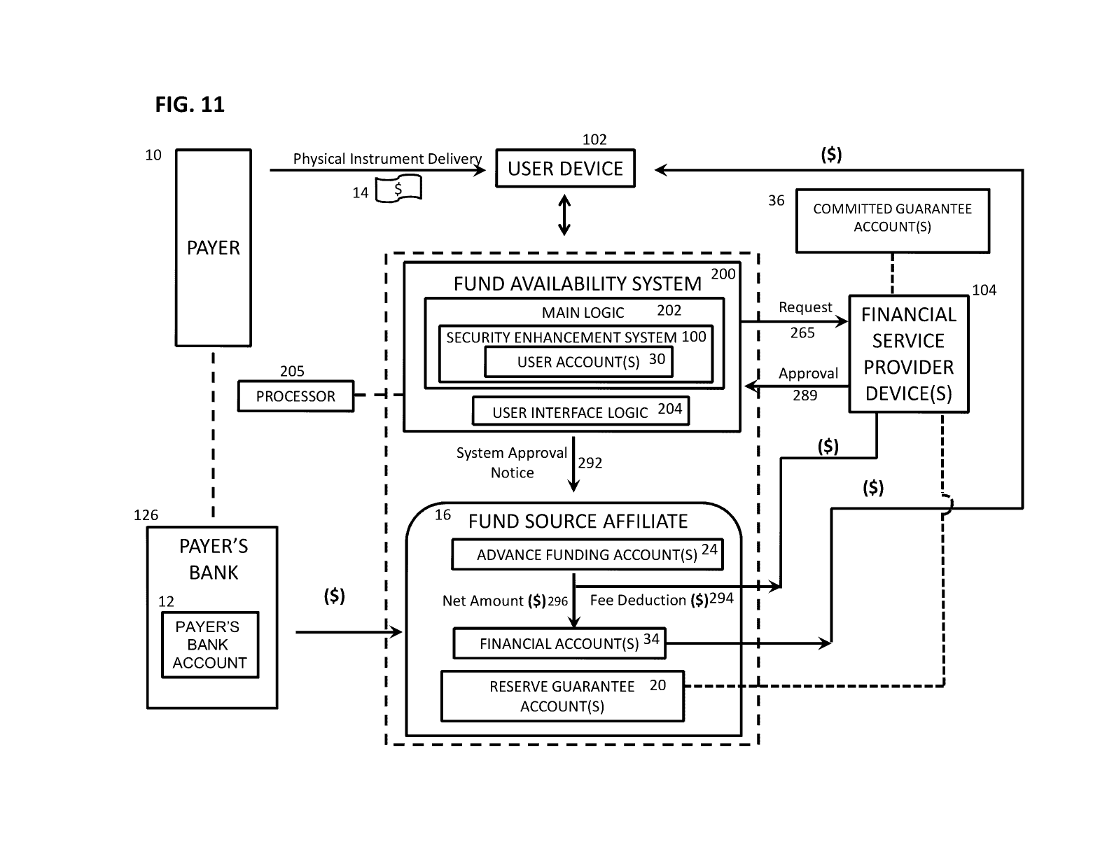

As illustrated in FIG. 11, the fund availability system 200, in an embodiment, includes main logic 202 and user interface logic 204, such as a mobile application or mobile software adapted for use by payees and other users 32. The main logic 202 includes the security enhancement system 100 which, in turn, includes a plurality of user accounts 30. In an embodiment, the fund availability system 200 also includes one or more data storage devices (e.g., databases) which store such logic, software, libraries, files and data processed by the main logic 202 and user interface logic 204. The main logic 202 determines the general function of the fund availability system 200, including the storing and processing of data for the service accounts 28 (FIG. 1) of the financial service providers 22. The user interface logic 204 controls the graphical user interfaces presented to the users 32 and enables the users 32 to remotely or electronically cash or deposit instruments 14 possessed in physical form.

In an embodiment, the main logic 202 and user interface logic 204 include one or more computer programs, software modules or computer code sets executable by one or more controllers, central processing units or processors, including, but not limited to, processor 205. Depending upon the embodiment, the user interface logic 204 includes: (a) a mobile application downloadable to mobile user devices 102; or (b) a web or online interface, a webpage, a website, a web portal or a network portal.

In an embodiment, the fund availability system 200 includes encryption software or computer code to protect personal data and financial information. In an example illustrated in FIG. 2, the fund availability system 200 encrypts the routing number 46, account number 48, check number 50, maker name 47, payee's first and last name 49, payee's social security number, and payee's date of birth. The fund availability system 200 implements this encryption for remote data transmissions and also for storage in the one or more databases of the fund availability system 200.

Referring to FIGS. 1 and 11, in an embodiment, each financial service provider 22 has a contractual, corporate or legal relationship with one or more fund source affiliates 16. For example, a fund source affiliate 16 can be a bank, and a financial service provider 22 can be a customer or partner of such bank. It should be appreciated, however, that in other embodiments, a single entity or a single organization performs all of the functions of the financial service provider 22 and the fund source affiliate 16.

In the embodiment illustrated in FIG. 11, the fund source affiliate 16 has or otherwise manages, among other accounts: (a) a plurality of advance funding accounts 24 associated with a plurality of different financial service providers 22; (b) a plurality of financial accounts 34 owned by a plurality of enrolled or registered users 32; and (c) a plurality of reserve guarantee accounts 20 funded by a plurality of different financial service providers 22.

In operation of one example, a financial service provider 22 deposits funds (e.g., $20,000) into its reserve guarantee account 20 held by its fund source affiliate 16. These reserve funds remain in such reserve guarantee account 20 to cover any bad check or insufficient fund events, as described below.

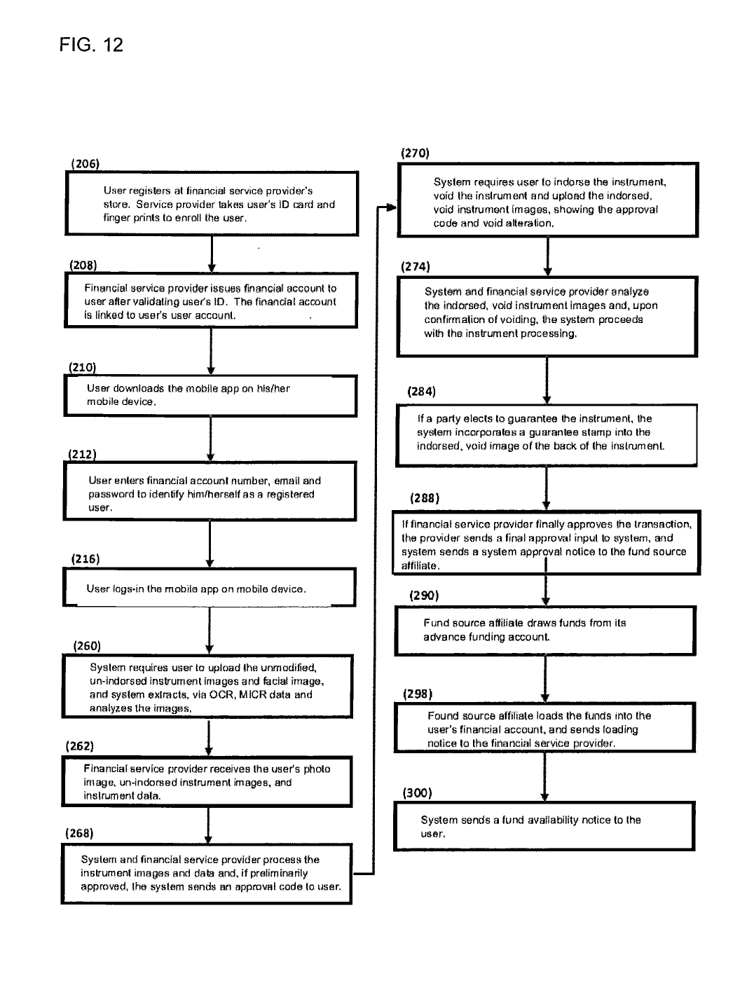

As illustrated by block 206 in FIG. 12, a user 32 (e.g., an employee or freelance consultant) visits a brick-and-mortar store of financial service provider 22 and opens a mobile cashing customer account 26 (FIG. 1), enrolling or registering with the fund availability system 200. In that process, the service provider representative inspects the user's personal identification cards, verifies his/her identity and creates records and a file for the user 32. The service provider representative takes the user's photo using a camera, scans his/her ID cards (e.g., driver's license card), and scans or captures his/her fingerprints and other biometrics for future cross matching and verification purposes.

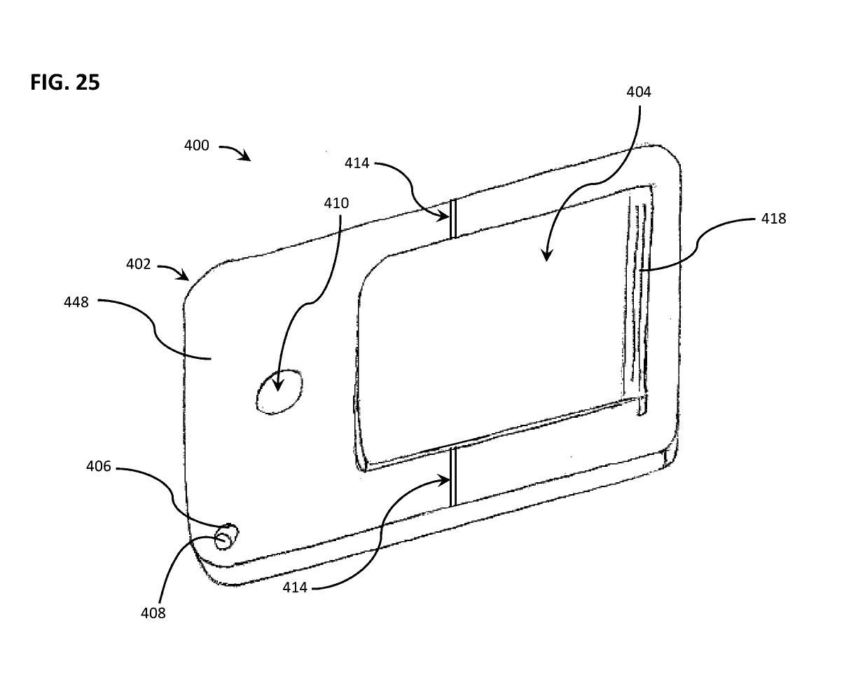

In an example, the fund source affiliate 16 had previously issued a batch of payment cards to the financial service provider 22, authorizing the financial service provider 22 to distribute the payment cards to the users 32. In this example, as illustrated by block 208, the representative provides the user 32 with one of these payment cards. Such payment card is linked to a financial account 34 issued to and owned by the user 32. The financial service provider 22 can also provide the user with an instrument voiding device 400 (FIGS. 25-33). Next, the user 32 downloads the user interface logic 204 onto his/her mobile user device 102 as illustrated by block 210.

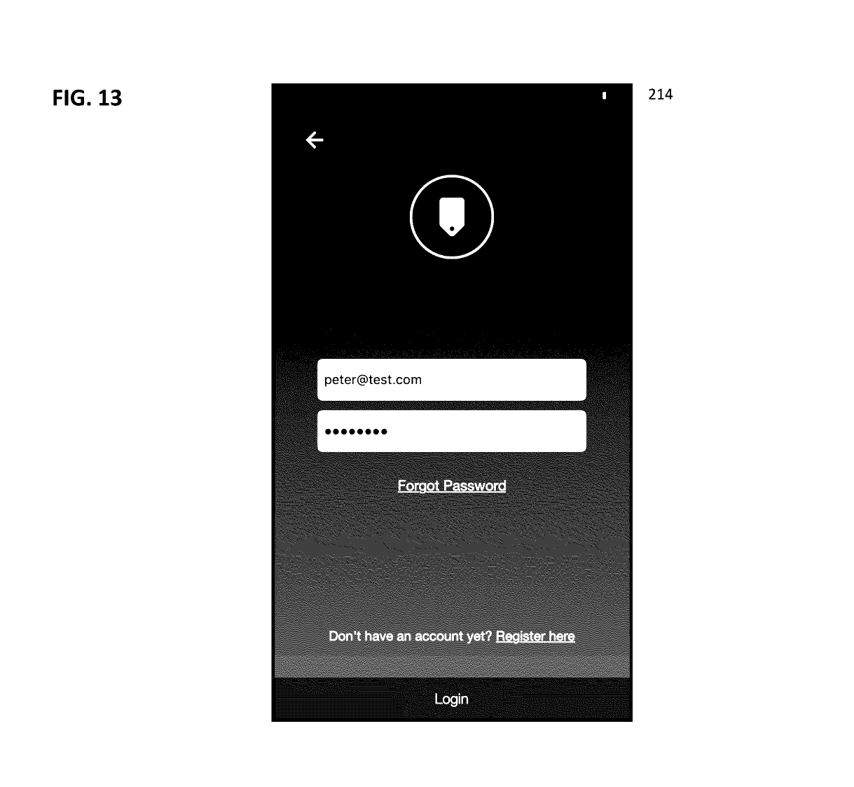

In an example, a payer 10 (e.g., a hiring party or employer) mails or delivers a physical form of instrument 14 (e.g., a $100 paper check) to the user 32, exemplified as “John Doe” in FIG. 2. After receiving the instrument 14 in physical form, the user 32 opens or activates the user interface logic 204 using his/her mobile user device 102. To do so, the fund availability system 200 requires the user 32 to enter her/her credentials, including, but not limited to, a username, password, payment card number, email address and biometric data, as illustrated by block 212 and interface 214 shown in FIG. 13. Next, the fund availability system 200 enables the user 32 to login or otherwise initiate a session for an instrument-based transaction, as illustrated by block 216.

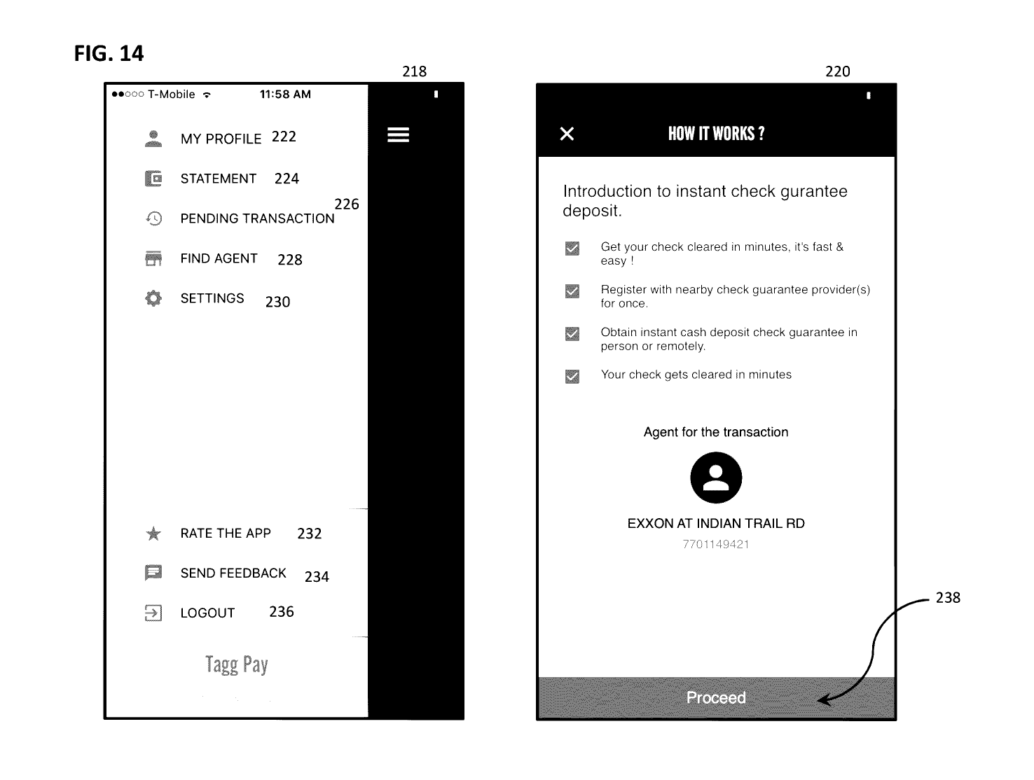

Once logged-in, the fund availability system 200 is operable to display an interface 218, as illustrated in FIG. 14. Interface 218 provides a plurality of hyperlinks, including the My Profile button 222, Statements button 224, Pending Transactions button 226, Finding Agents button 228, Settings button 230, Rate the App button 232, Send Feedback button 234 and Logout button 236. Also, the fund availability system 200 is operable to display an interface 220 describing how the fund availability system 200 works, as illustrated in FIG. 14.

When the user 32 selects the My Profile button 222, the fund availability system 200 displays a plurality of personal settings (including username, password, email address and alert settings), information related to the user's financial accounts 34 and information related to any of the user's committed guarantee accounts 36. The fund availability system 200 enables the user 32 to customize and set these settings as well as enter financial data to couple his/her financial accounts 34 and committed guarantee accounts 36 to the fund availability system 200.

When the user 32 selects the Statements button 224, the fund availability system 200 displays reports or a historical list or charts describing the user's past transactions. For example, the fund availability system 200 displays the charts by week, month or quarter. When the user 32 selects the Pending Transactions button 226, the fund availability system 200 displays a descriptive list or charts describing the user's pending transactions.

When the user 32 selects the Finding Agents button 228, the fund availability system 200 displays a locator, map or list associated with the financial service providers 22 physically located within the vicinity (e.g., ten mile radius or zip code area) of the current location of the user's mobile user device 102. In an embodiment, the fund availability system 200 includes a global positioning satellite (GPS) software module to enable the geographic tracking of the mobile user device 102 for locating nearby financial service providers 22. In an embodiment, the fund availability system 200 includes a user-based rating module, enabling users 32 to grade or rate the listed financial service providers 22 as well as to provide a narrative review of the users' experiences with the financial service providers 22. Depending upon the embodiment, the fund availability system 200 enables the user 32 to select a desired financial service provider 22 as a default for all future transactions, or the fund availability system 200 enables the user 32 to select and affirm the desired financial service provider 22 for each new transaction.

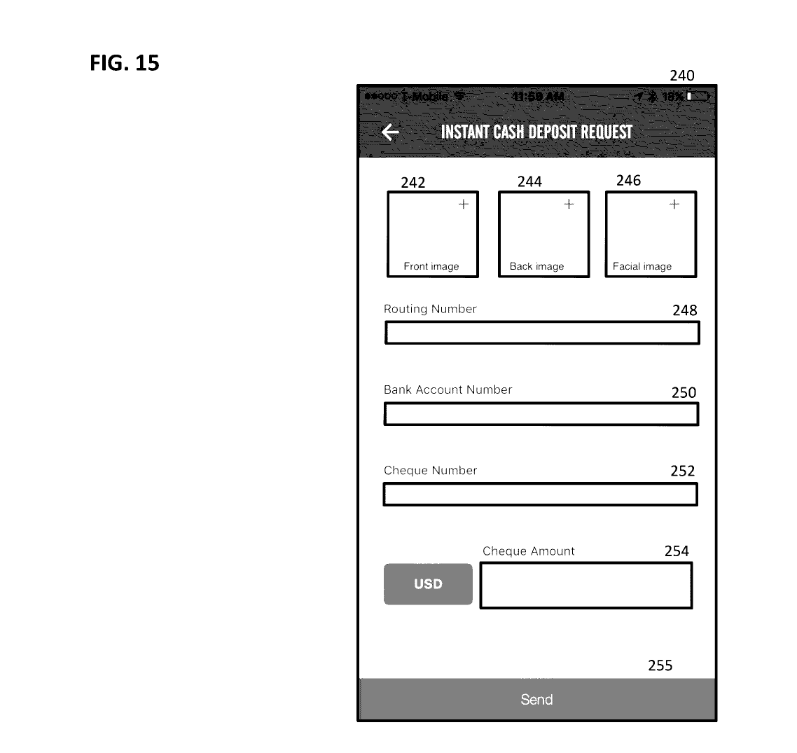

When the user 32 selects or clicks on the proceed button 238 (FIG. 14), the fund availability system 200 displays interface 240 illustrated in FIG. 15. Interface 240 includes: (a) a front image upload window 242 operable to receive, store and display the front image 54 (FIG. 2) generated by the user device 102; (b) a back image upload window 244 operable to receive, store and display the back image 56 (FIG. 2) generated by the user device 102; (c) a biometric or facial image upload window 246 operable to receive, store and display the facial image 124 (FIG. 5) generated by the user device 102; (d) a routing number data field 248 configured to receive, store and display the routing number entered by the user 32; (e) a bank account data field 250 configured to receive, store and display the bank account number entered by the user 32; (f) an instrument or check number data field 252 configured to receive, store and display the instrument or check number 51 (FIG. 2) entered by the user 32; and (g) an instrument or cheek amount data field 254 configured to receive, store and display the monetary gross amount 40 (FIG. 2) entered by the user 32.

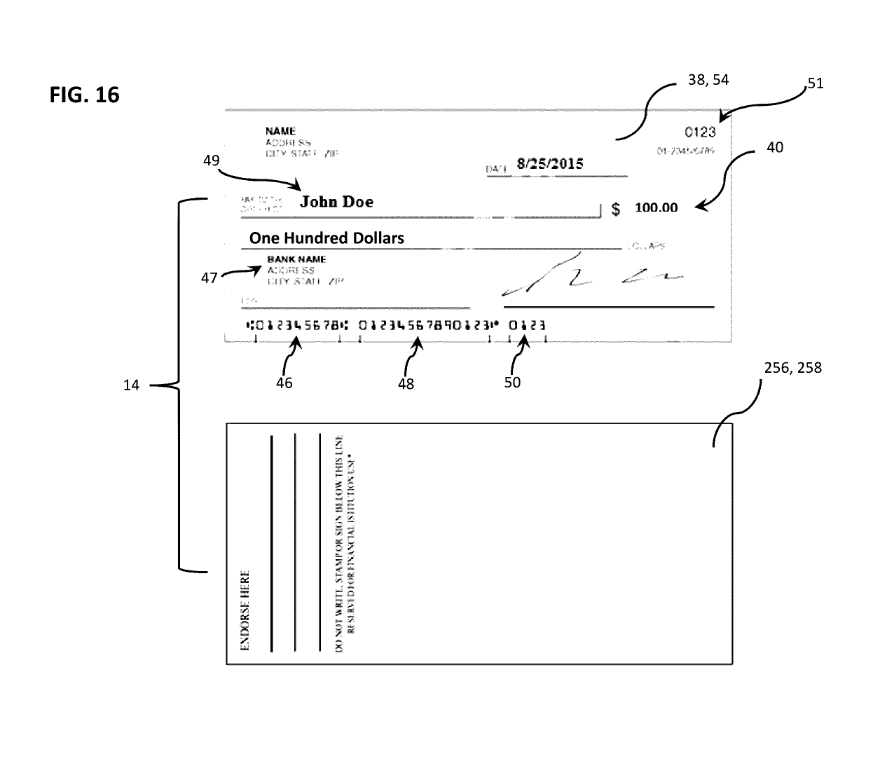

The fund availability system 200 displays a message instructing the user 32 not to sign or indorse the instrument 14. Referring to FIG. 16, the fund availability system 200 requires the user 32 to: (a) photograph the unmodified front 38; (b) photograph the unmodified back 256 (e.g., the original, unsigned, un-indorsed version) of the instrument 14, that is, the original version excluding the indorsement 44 shown in FIG. 6; and (c) record, image or photograph his/her face or other body portion, resulting, for example, in biometric facial image 124 (FIG. 5). Depending upon the embodiment, the fund availability system 200 also requires the user 32 to transmit supplemental biometric images, such as fingerprints captured by a fingerprint scanner or reader of the user device 102.

This requirement helps to verify the user's identity and also helps to ensure that the instrument 14 presented by the user 32 has not been previously cashed or deposited. The user 32 then records or takes digital photographs of such unmodified front 38, unmodified back 256 and his/her face, resulting in images 54 and 258 (FIG. 16) and facial image 124 (FIG. 5).

As illustrated by block 260, the user 32, as required by the fund availability system 200, uploads the images 54, 258 and 124. In a first security screening, the fund availability system 200 then confirms whether the images 54, 258 indicate that the instrument 14 has been previously signed, endorsed or modified. If the fund availability system 200 detects any such signature, endorsement or modification, the fund availability system 200 sends an alert to the financial service provider 22 of potential fraud, such as an attempt to cash the same instrument more than once. The financial service provider 22 may then decline the user's request for the transaction. If the fund availability system 200 does not detect any such signature, endorsement or modification, the user 32 passes the first security screening, and the fund availability system 200 performs the additional steps described below. If the user 32 does not pass the first security screening, the fund availability system 200 or the financial service provider 22 can deny the user's request 265 (FIG. 11).

In an embodiment, the fund availability system 200 prevents the user 32 from proceeding with the transaction until the user 32 completely provides the images 54, 258 and 124, and until the user 32 inputs the data in fields 248, 250, 252 and 254, as illustrated in FIG. 15.

In an embodiment, the fund availability system 200 includes a duplicate instrument warning module for operating a second security screening. As an extra layer of security, the duplicate instrument warning module determines whether an individual is attempting to cash or deposit the same instrument 14 more than once. In an embodiment, the fund availability system 200 stores data related to all instruments 14 cashed or cleared through the fund availability system 200. For example, for each such instrument, such data includes the date when such instrument was cashed or deposited and the following four data elements: (a) the routing number 46; (b) the account number 48; (c) the instrument dollar amount (e.g., gross amount 40); and (d) the instrument or check number 50. In operation, the duplicate instrument warning module electronically compares such data elements to the data elements of all other instruments stored in the duplicate instrument warning module, looking for matches. If the duplicate instrument warning module finds a match of all four of such data elements, such module transmits a STOP alert to the financial service provider device 104 together with a red indicator. If such module finds a match of some but less than all of such four data elements (e.g., three of the four data elements), such module transmits a CAUTION alert to the financial service provider device 104 together with an orange indicator. Based on these alerts, such representative can decline a transaction request 265 when receiving a STOP alert or investigate potential fraud when receiving a CAUTION alert before proceeding with such transaction. In an embodiment, such duplicate instrument warning module is electronically coupled to the instrument databases of one or more external banks, such as national bank chains. In such embodiment, such module searches such bank databases and the fund availability system 200 database to perform the match analysis and generate the alerts described above.

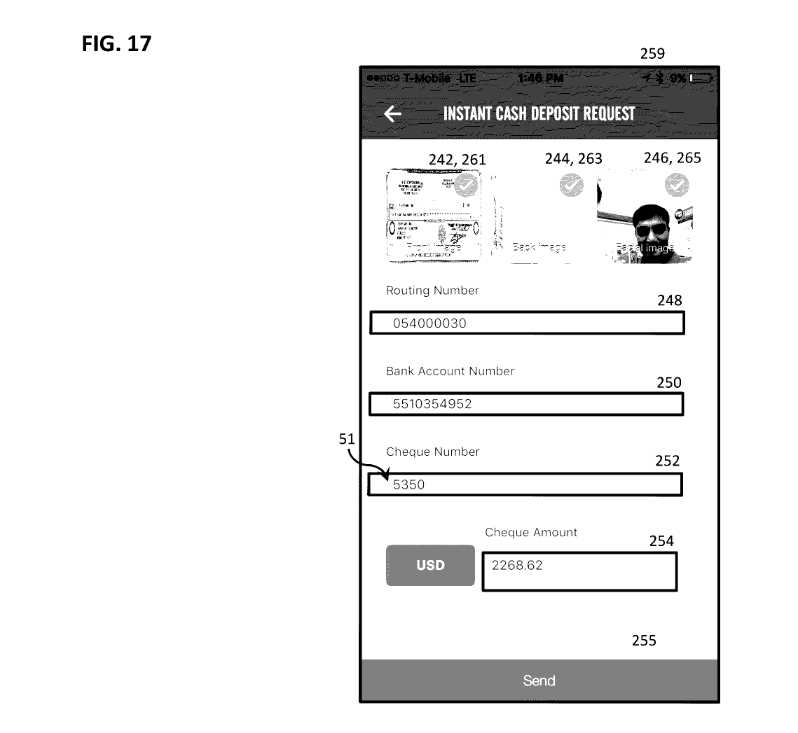

After the user 32 passes the first and second security screenings, the fund availability system 200 activates the send button 255 (FIG. 15), enabling the user 32 to click it. As illustrated in FIG. 17, the fund availability system 200 then displays a populated interface 259. In an embodiment, the fund availability system 200 enables the user 32 to sequentially: (a) photograph and upload front image 54 followed by displaying a thumbnail front image 261, then (b) photograph and upload back image 258 followed by displaying a thumbnail back image 263, and then (c) photograph and upload facial image 124 followed by displaying a thumbnail facial image 265.

Referring to block 260 in FIG. 12, after the user 32 clicks the send button 255 (FIG. 17), the fund availability system 200 performs optical code reading (OCR) to extract the routing, bank account and check numbers from the front image 54. In a third security screening, the fund availability system 200 utilizes facial recognition methods, as described above, to analyze the facial image 124 (FIG. 5). If the fund availability system 200 determines that the facial image 124 does not sufficiently match the ID photograph loaded into the fund availability system 200 by the financial service provider 22, the fund availability system 200 sends or generates an alert visible to the financial service provider 22, indicating an actual or potential mismatch problem. Depending upon the embodiment, the fund availability system 200 or the financial service provider 22 can automatically decline the user's request 265 if the fund availability system 200 determines such actual or potential mismatch problem.

In an embodiment, the fund availability system 200 generates the results of the system's digital comparison of: (a) the user's facial image 124 (FIG. 5) received through the mobile user device 102 to the photo received through the in-person, enrollment meeting at the brick-and-mortar store of the financial service provider 22; and (b) any fingerprints received through the mobile user device 102 to the fingerprints received through the in-person, enrollment meeting at the brick-and-mortar store of financial service provider 22. The service provider representative can review these system-generated results to verify the identity of the individual requesting to perform the instrument-based transaction. Also, such representative can manually and visually perform such comparison as a double check for identity verification.

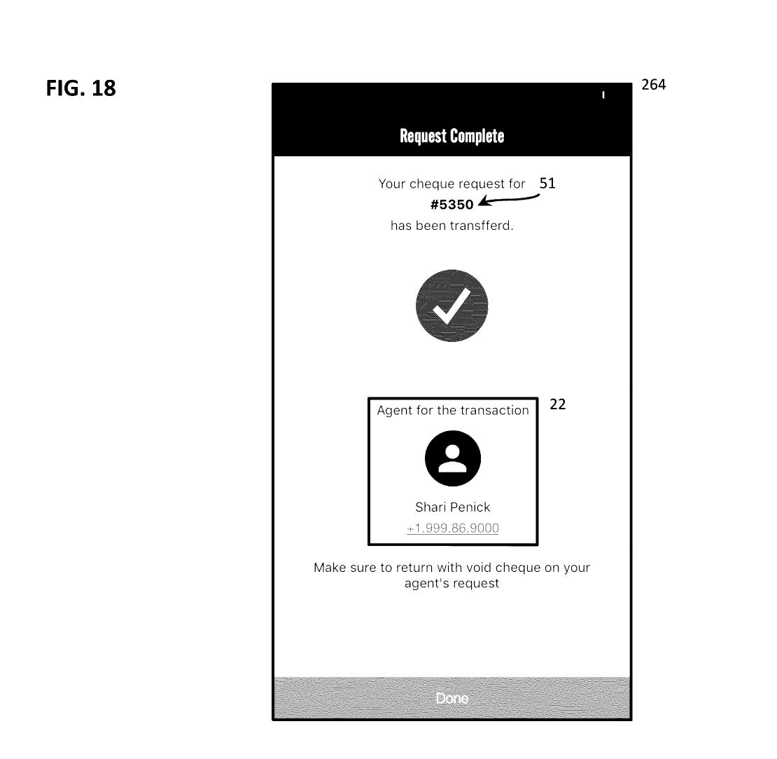

If neither the fund availability system 200 nor the financial service provider 22 blocks the transaction due to a facial, fingerprint or biometric mismatch, the user 32 passes the third security screening, and the fund availability system 200 displays an interface 264 (FIG. 18), confirming that the user's request 265 (FIG. 11) has been transmitted to the financial service provider device 104. Then, the financial service provider 22 is able to access the stored data using a financial service provider device 104 (FIG. 11), as illustrated by block 262. In an embodiment, the fund availability system 200 electronically sends an alert (e.g., text message, direct message, email or phone call) to the financial service provider 22 to notify the financial service provider 22 that a user 32 has uploaded images and data for a new transaction request 265. At this point, the financial service provider 22 can evaluate such images and data, comparing them to information in the files or records of the financial service provider 22. Depending upon the embodiment, the financial service provider 22 can perform this evaluation manually, semi-automatically or automatically.

Next, the financial service provider 22 exercises its judgment and assessment of the request 265 as part of a fourth security screening. If the financial service provider 22 determines, in its discretion, to preliminarily approve the request 265, the user 32 passes the fourth security screening, and the fund availability system 200 displays an acknowledgement message to the user 32, including, without limitation, pre-check cashing disclosures, legal terms and licensure status, ABA number, bank account number, check number, check date, payee name on the check, gross amount 40 (FIG. 2), check casher's fee 294 (FIG. 11), and the net amount 296 (FIG. 11) that the user 32 will receive. At this stage, the fund availability system 200 enables the user 32 to withdraw, accept or decline the instrument-based transaction.

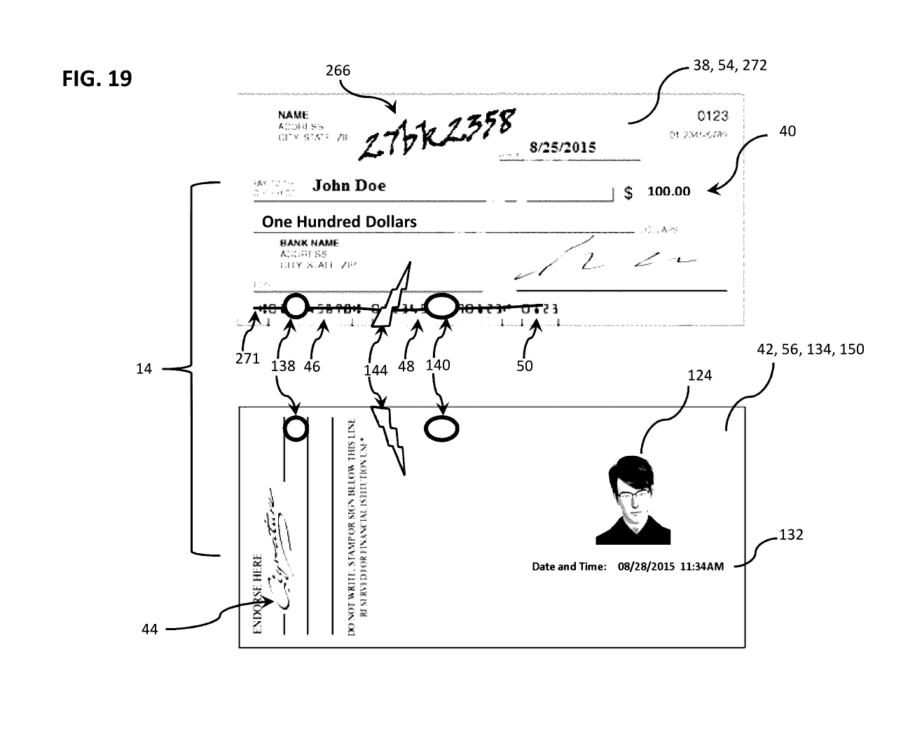

If the user 32 transmits his/her acceptance to the fund availability system 200, the financial service provider 22 electronically provides a preliminary approval input to the fund availability system 200. As illustrated by block 268 of FIG. 12 and FIG. 19, in response to the preliminary approval input, the fund availability system 200: (a) displays to the user 32, a unique approval code 266, such as 27bk2358, generated by the fund availability system 200; (b) instructs the user 32 to sign or indorse the back 42 of the instrument 14; (c) instructs the user 32 to mark, print or hand-write the approval code 266 on the front 38 of the instrument 14, as illustrated in FIG. 19; (d) instructs the user 32 to mark or draw a voiding line 271 (FIG. 8) through part of all of the numbers 46, 48, 40; and (e) instructs the user 32 to structurally alter the instrument 14 by punching, poking or creating one or more holes 138, 140 or a tear 144 in the physical form of the instrument 14 using a sharp object or the voiding device 400 described below. One or more of the voiding line 271, holes 138, 140 and tear 144 helps ensure that the instrument 14 is not fraudulently used more than once in the future. Effectively, this voiding requirement helps remove used instruments 14 from circulation to reduce fraud.

In a fifth security screening, as illustrated by FIG. 19, the fund availability system 200 then requires the user 32 to: (a) scan, record or photograph the front 38 to generate a void front image 272 displaying the approval code 266; and (b) scan, record or photograph the back 42 to generate a void back image 150. As required by the fifth security screening of the fund availability system 200, the user 32 uploads or transmits the images 272, 150 to the fund availability system 200, as illustrated by block 270 in FIG. 12. Depending upon the embodiment, the fund availability system 200 automatically analyzes the images 272, 150, the financial service provider 22 manually analyzes the images 272, 150, or the financial service provider 22 semi-automatically analyzes the images 272, 150 through a combination of manual steps and automatic steps performed by the fund availability system 200. In this analysis, as illustrated by block 274 in FIG. 12, the fund availability system 200 or the financial service provider 22 confirms whether the images 272, 150 indicate the presence of the approval code 266 and whether the instrument 14 has been indorsed and voided through physical alteration or destruction. If the financial service provider 22 or fund availability system 200 denies such confirmation, the financial service provider 22 may deny the user's request 265 for the transaction, or the financial service provider 22 may confer with the user 32 regarding corrective action. It should be appreciated that, in an embodiment, the financial service provider 22 has ultimate control and decision-making authority for deciding whether to deny such confirmation.

If the fund availability system 200 or financial service provider 22 does provide such confirmation, the user 32 passes the fifth security screening, and the financial service provider 22 then decides whether to act as guarantor for the instrument 14. If the financial service provider 22 elects to guarantee the funds related to the instrument 14, the financial service provider 22 electronically provides a guarantee input to the fund availability system 200. As a guarantor, the financial service provider 22 is secondarily liable for the user's (payee's) debt or performance in accordance with the instrument 14.

In an embodiment, the fund availability system 200 enables a variety of parties to act as guarantors for the user 32. Referring to FIGS. 1 and 11, each user 32 may voluntarily register with the fund availability system 200 to assist another user 32. For example, a home construction contractor may provide an instrument 14 to its subcontractor. The subcontractor may register as a user 32, linking his/her financial account 34 to his/her user account 30. The home construction contractor may also register as a user 32, linking his/her committed guarantee account 36 to the user account 30 of the subcontractor. The committed guarantee account 36 includes any suitably-funded financial account of the home construction contractor, including, but not limited to, a financial account 34, a bank account, a bank debit card or a credit card (e.g., Visa® or MasterCard®). If the instrument 14 undergoes an insufficient funds event, the fund availability system 200 will draw funds from the committed guarantee account 36 to recover the loss incurred by the financial service provider 22 or fund source affiliate 16.

In another example, an employer or hiring party may provide an instrument 14 to a user 32. To find a guarantor for the instrument 14, the fund availability system 200 may display a social network link, coupling the fund availability system 200 to one or more network-accessible social network sites, such as Facebook®, Instagram® or LinkedIn®. The user's family members, friends and associates socializing on such network sites may decide to assist the user 32 by acting as a guarantor. By coupling to such sites, the fund availability system 200 enables each such family member, friend and associate to register as a user 32, linking his/her committed guarantee account 36 to the user account 30 of the user 32. The committed guarantee account 36 includes any suitably-funded financial account of such assisting user 32, including, but not limited to, a financial account 34, a bank account, a bank debit card or a credit card. If the instrument 14 undergoes an insufficient funds event, the fund availability system 200 will draw funds from the committed guarantee account 36 of the assisting user 32 to recover the loss incurred by the financial service provider 22 or fund source affiliate 16.

In yet another example, the assisting user 32 owns $500 in his/her financial account 34. The assisted user 32 has requested to cash a $100 instrument 14. To help, the assisting user 32 guarantees such instrument 14. In such event, the fund availability system 200 or financial service provider 22 initially charges $100 to the assisting user's financial account 34. If and after such instrument 14 is cleared by the fund source affiliate 16, the fund availability system 200 or financial service provider 22 issues a refund or credit to the assisting user's financial account 34, transferring the $100 back to the assisting user 32. It however, such instrument 14 is bad due to insufficient funds, the financial service provider 22 retains the $100 less any recovery amount paid by assisted user 32.

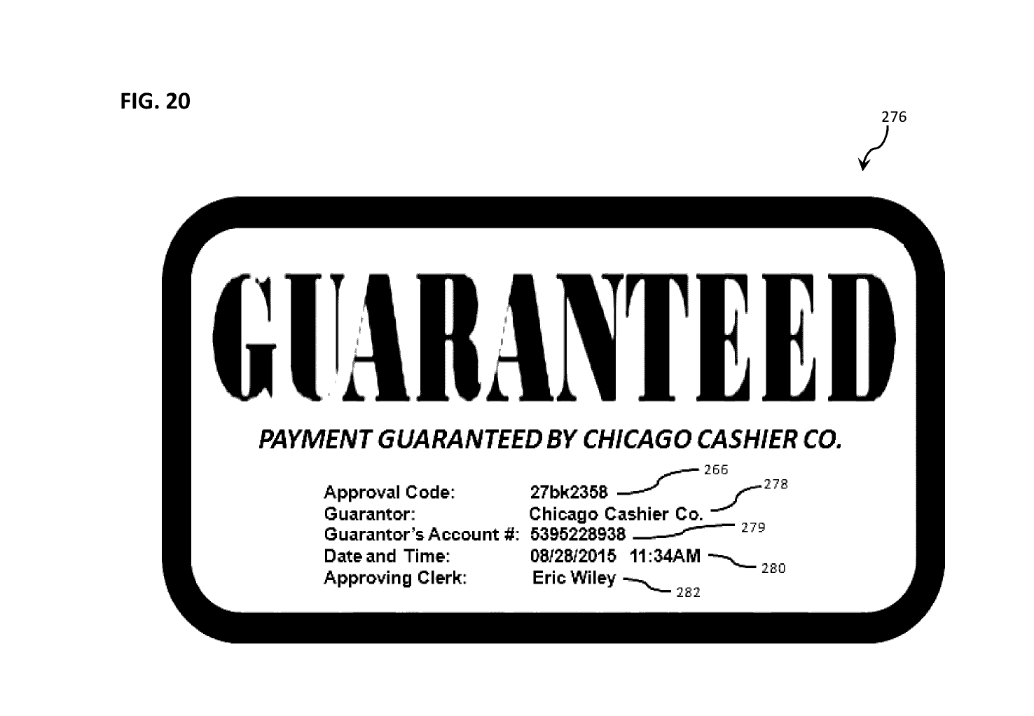

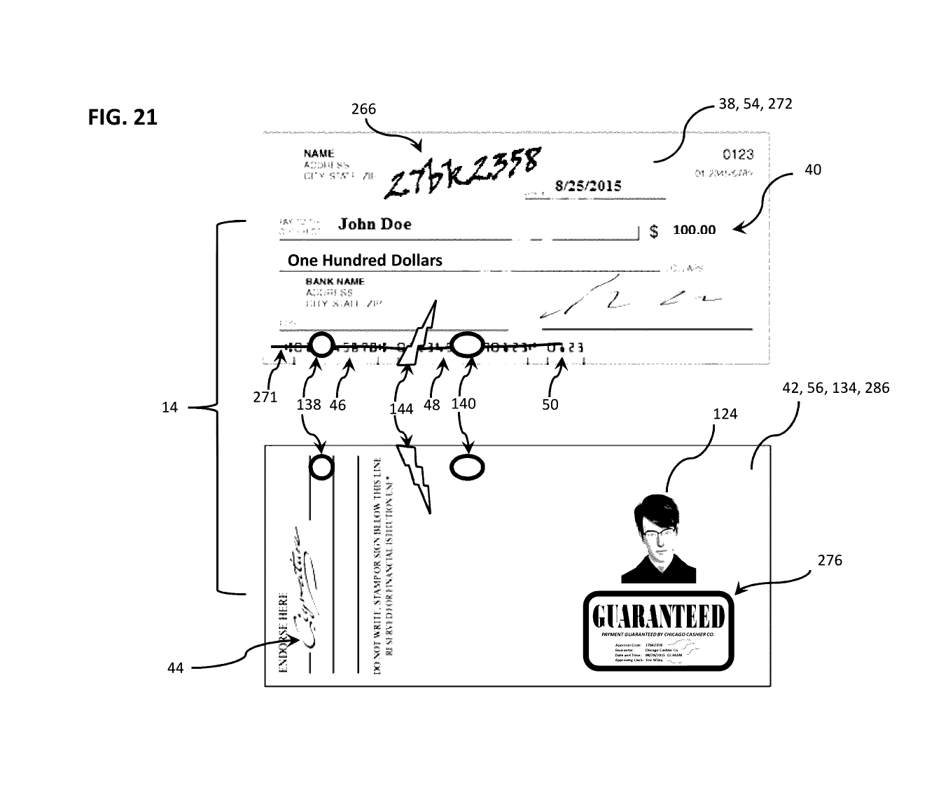

As illustrated in FIGS. 20-2, in response to a guarantee input from a financial service provider 22 or assisting user 32, the fund availability system 200 generates a guarantee stamp image 276. The size, shape, format, location and configuration of the guarantee stamp image 276 can vary depending upon the embodiment. In one example, the guarantee stamp image 276 displays a message such as “PAYMENT GUARANTEED BY PARTY X” or “PARTY X GUARANTEES PAYMENT.” In the example shown in FIGS. 20-21, the guarantee stamp image 276 includes and displays “PAYMENT GUARANTEED BY CHICAGO CASHIER CO.,” the approval code 266, the guarantor's name 278, the guarantee account number 279 of the reserve guarantee account 20 funded by the guarantor, the guarantee date and time stamp 280, and the personal name 282 of the check casher clerk or representative who approved the guarantee.

In an embodiment, the guarantee date and time stamp 280 corresponds to a time-sensitivity property of the instrument 14. For example, the fund availability system 200 specifies a designated time period, such as thirty minutes, ten minutes or five minutes. The system's clock automatically starts at the time displayed in the guarantee date and time stamp 280. If the user's request to cash or deposit the instrument 14 is not approved within such designated time period, the fund availability system 200 declines the request and requires the user 32 to initiate a new request.

In addition, as illustrated by block 284 of FIG. 12 and FIG. 21, the fund availability system 200 incorporates or embeds the guarantee stamp image 276 into the back indorsed, void image 150 (FIG. 19) of the instrument 14. This results in a collective instrument back image 286 including, based upon or resulting from the merger of the indorsed void image 150 and guarantee stamp image 276. The embedding of the user's photo image 124 and guarantee stamp image 276 serves as an additional security feature. Such security feature also serves as an additional or double indorsement, where the user 32 has primary responsibility for insufficient fund events, and the guarantor has secondary responsibility for insufficient funds events.

In the example illustrated in FIG. 21, the collective instrument back image 286 includes a single static image (e.g., an image having format JPG, TIF, PNG or GIF) which incorporates or merges the indorsement image 44, facial image 124 and guarantee stamp image 276. In an embodiment, the fund availability system 200 performs such merger by graphically combining the separate images of the instrument back 56, indorsement image 44, facial image 124 and guarantee stamp image 276. In another embodiment, the fund availability system 200 performs such merger by combining the separate sets of digital or binary code corresponding to the different images 56, 44, 124 and 276 into a single, collective set of digital or binary code. The fund availability system 200 executes the collective binary code to generate the collective instrument back image 286.

In a sixth security screening, the financial service provider 22 reviews and assesses the instrument front image 272 and the collective instrument back image 286. The financial service provider 22 can elect to decline or finally approve the instrument-based transaction after reviewing the instrument front image 272 and the collective instrument back image 286. If the case of a final approval, as illustrated by block 288 in FIG. 12: (a) the financial service provider 22 electronically provides a final approval input or final approval 289 (FIG. 11) to the fund availability system 200; and (b) the fund availability system 200 automatically transmits a transfer notice or system approval notice 292 (FIG. 11) to the fund source affiliate 16, together with the guaranteed check images 272, 286 (FIG. 21). In an embodiment, the fund availability system 200 also automatically transmits to the fund source affiliate 16, the data corresponding to the instrument 14 in a text file or other suitable format, including: (a) the complete MICR data having the routing, account and check numbers 46, 48 and 50, respectively; (b) the approval code 266; (c) the guarantor's name 278; (d) the guarantor's bank or financial account number 279; and (e) the name 282 of the representative who authorized or assessed the guarantee.

The fund source affiliate 16 then instantly or automatically draws the gross amount 40 (in this example, $100) from the advance funding account 24 associated with the financial service provider 22, as illustrated by block 290 in FIG. 12. As illustrated in FIG. 11, the fund source affiliate 16 or its device splits the gross amount 40 into a fee deduction amount 294 and a net amount 296. As illustrated by block 298 in FIG. 12: (a) the fund source affiliate 16 electronically credits or transfers the net amount 296 to the user's financial account 34; (b) the fund source affiliate 16 electronically credits or transfers the fee deduction amount 294 to the financial service provider 22; and (c) the fund source affiliate 16 electronically sends a transfer confirmation notice to the fund availability system 200 or otherwise to the financial service provider 22.

For example, the financial service provider 22 may charge the user 32 a five percent (5%) service fee 294. In that case, $95 would be credited or transferred to the payee's financial account 34, and $5 would be credited or transferred to the financial service provider 22. As illustrated by block 300 in FIG. 12, in an embodiment, the fund availability system 200 sends a confirmation message to the user 32, indicating that, for example, the $95 amount has been deposited into the user's financial account 34. At this time, the user 32 may use the $95 to pay bills and buy products and services, whether online or at brick-and-mortar stores throughout the world. In an embodiment, this entire transaction occurs in a single transaction session as a quick-cashing session. For example, this session can be entirely completed within fifteen minutes or less, depending upon the embodiment and particulars of the transaction.

Referring to FIG. 11, after the transaction is completed, the fund source affiliate 16 clears the instrument 14 through communication with the payer's bank 126. After clearance, the payer's bank 126 debits $100 from the payer's bank account 12 and credits or transfers the $100 to the fund source affiliate 16. The fund source affiliate 16 then places the $100 in the advance funding account 24. This process can take one, two or more business days. It is possible that, during this process, it can be found that the payer's account 12 at its bank 126 has insufficient funds (e.g., less than $100). In such insufficient funds event, the fund availability system 200 instructs or requires the fund source affiliate 16 to attempt to recover the loss in the following order: (a) first, by drawing from all available funds in the user's financial account 34; and (b) second, if a loss remains, by drawing from the reserve guarantee account 20 or the committed guarantee account 36, as applicable. The financial service provider 22 may then take legal action against the user 32 to collect and recover the $95. The user 32 may, in turn, take legal action against the payer 10 to collect and recover the $95 owed to the financial service provider 22.

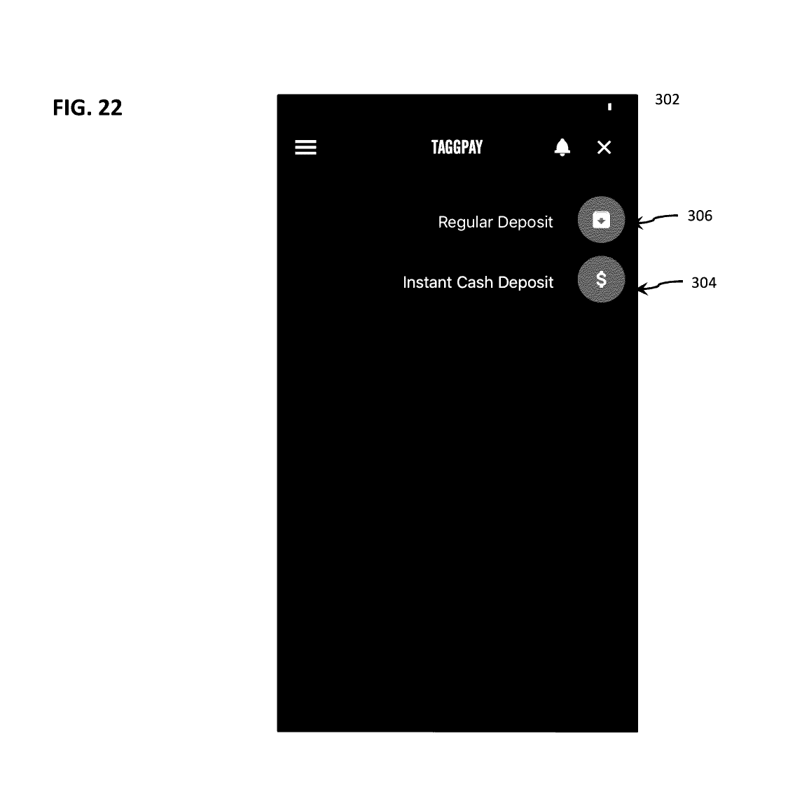

In an embodiment, the fund availability system 200 provides the user 32 with the option of quick funding as described above or regular funding. As illustrated in FIG. 22, the fund availability system 200 displays an interface 302 having an instant or quick funding button 304 and a regular funding button 306. The quick funding service is associated with a relatively high fee deduction 294 (e.g., 5%). The regular funding service is associated with a lower fee deduction 294 (e.g., 2%). If the user 32 does not need to receive funds quickly, the user 32 may select the regular funding button 306.

In an embodiment, for regular funding, the fund availability system 200 performs all of the verification, analysis and processing steps described above, but there is no guaranteeing of the instrument 14 by the financial service provider 22 or any other user 32. Consequently, the fund source affiliate 16 does not advance funds to the user's financial account 34. Rather, the fund source affiliate 16 transfers the net amount 296 to the user's financial account 34 only after the instrument 14 is cleared with the payer's bank 126. This clearance process, which can be controlled by the Federal Reserve Bank, can occur over a relatively long period of time, such as one, two, three or more business days.

In an embodiment, for quick funding, the fund availability system 200 performs all of the verification, analysis, processing and guaranteeing steps described above. With the benefit of the guarantee functionality, a financial service provider 22 or a secondary user 32 has guaranteed the instrument 14. Therefore, fund source affiliate 16 advances the net amount 296 to the user's financial account 34. Depending upon the embodiment, this fund advancement occurs instantly, live, in real time, immediately, promptly, quickly or automatically. For example, the fund advancement occurs within sixty minutes after the user's request 265, within forty-five minutes after the user's request 265, within thirty minutes after the user's request 265, within fifteen minutes after the user's request 265, within five minutes after the user's request 265, within one minute after the user's request 265, within thirty seconds after the user's request 265, within ten seconds after the user's request 265 or within one second after the user's request 265.

In another embodiment, the fund availability system 200 does not provide the user 32 with the choice or option of selecting between different funding methods. For example, the fund availability system 200 does not display interface 302. Instead, the fund availability system 200 automatically attempts the quick funding method by default. If the fund availability system 200 or financial service provider 22 declines the quick funding method based on the analysis described above, such as a denial of guarantee confirmation, the fund availability system 200 automatically proceeds to implement the regular funding method.

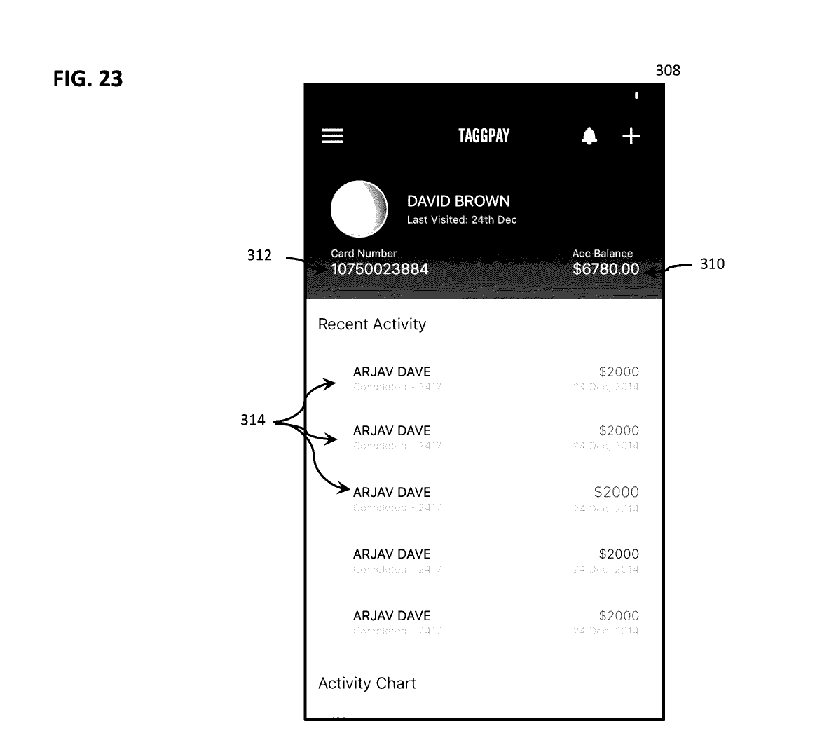

In an embodiment, when the user 32 presses the Statements button 224 (FIG. 14), the fund availability system 200 displays the recent activity interface 308 illustrated in FIG. 23. As shown, the interface 308 displays the user's balance 310 in his/her financial account 34, his/her financial account number 312 (e.g., payment card number), and a plurality of row 314 providing data regarding the historical transactions, including the payer's name, completion status, instrument or check number, transaction date and the net amount.

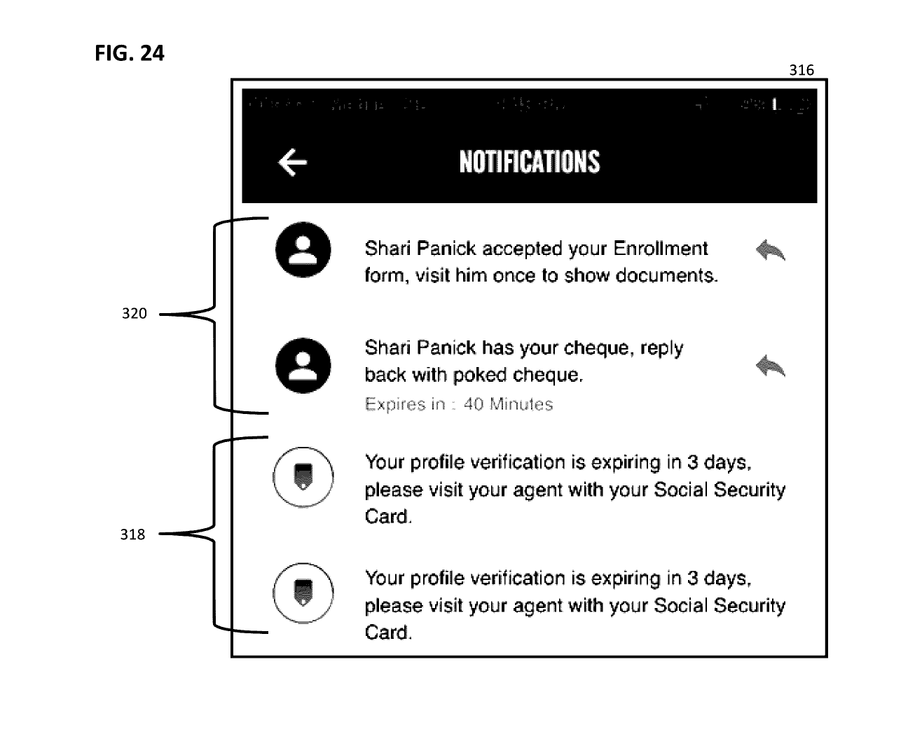

In an embodiment, the fund availability system 200 is operable to display a notification or message interface 316 to the user 32, as illustrated in FIG. 24. The messages displayed by the interface 316 can include messages automatically generated by the fund availability system 200, such as messages 318. The interface 316 can also display messages written or transmitted by the financial service provider 22, such as the messages 320.

In an embodiment, the fund availability system 200 detects and blocks any submission of externally-sourced, preexisting or aged images from an external source other than the memory transfer channel between the camera of the user device 102 and the user interface logic 204. In one example, the fund availability system 200 inspects the properties or data corresponding to each uploaded image 54, 56 and 124 (FIG. 6) to determine whether such image is aged by having a creation time more than fifteen minutes, ten minutes, five minutes, one minute, thirty seconds, ten seconds, five seconds or one second before the user presses the send button 255. In another example, the fund availability system 200 inspects the properties or data corresponding to each uploaded image 54, 56 and 124 to determine whether such image: (a) has an origin other than the camera of the user device 102; or (b) was created with a device other than the user device 102 which the user 32 used to become a registered user of the fund availability system 200. This security step helps reduce the risk of users submitting doctored or counterfeit instruments created outside of the session of the fund availability system 200.

In an embodiment, the financial service provider 22 is affiliated with a financial transaction processing entity or transaction facilitator. In this embodiment, the transaction facilitator establishes and manages the user's financial account (e.g., a prepaid payment card account) for the user 32. Such financial account is not established or managed by the fund source affiliate 16. In operation, the financial service provider 22 communicates with the transaction facilitator regarding the user's transaction request 265. If the financial service provider 22 and transaction facilitator approve the request 265, the device of the transaction facilitator electronically transmits the approval 289 to the fund availability system 200. In turn, the fund availability system 200 transmits the system approval notice 292 to the fund source affiliate 16. The fund source affiliate 16 then transfers the net amount 296 to the user's financial account established and managed by the transaction facilitator.

3.2 Administration

In an embodiment, the security enhancement system 100 and the fund availability system 200 each include an administration module for each of the service accounts 28 (FIG. 1). The administration module stores instrument transactional data, including, but not limited to, information related to: (a) all instruments 14 cashed or deposited within a selectable time window; (b) any instance where a single user 32 has cashed or deposited instruments 14 totaling a threshold (e.g., $10,000) or more in a single day; (c) a list of such users 32; (d) all bank deposits made by users 32 based on cashed instruments; and (e) instrument historical patterns of users 32 usable to detect money laundering or other illegal activities. Accordingly, the administration module includes legal violation algorithms or fraud detection algorithms which constantly, periodically or automatically monitor for behavioral patterns and generate transaction or user account freezes and alerts when a certain pattern is detected. The administration module generates configurable reports containing such information, together with payee information, maker account information, instrument amount, fee and amount paid to payee.

In an embodiment, the administration module is operable to generate an graphical user interface having a comparison template. The comparison template provides areas to display a plurality of biometric images in side-by-side arrangement. For example, the driver's license image of a user 32 can be displayed to the left or right of the facial image 124 of the user 32. The administration module is also operable to display a static or animated match or similarity indicator, or a match meter. The match meter indicates the variable degree to which one biometric image (e.g., driver's license image of a user 32) is similar to another biometric image (facial image 124). Alternatively, the administration module can be operable to display any other suitable type of match or similarity indicator, including, but not limited to, a color chart (e.g., green indicating a match, yellow indicating a possible match, and red indicating no match).

### 4. Instrument Voiding Methods

As described above, in an embodiment, each of the systems 100, 200 is operable to remove once-used instruments 14 from public circulation to help prevent individuals from fraudulently cashing or depositing the same instrument 14 more than once. As described above, in an embodiment, each system 100, 200 performs at least the following steps before receiving an approval 289 (FIG. 11) of the user's request 265 (FIG. 11) for an instrument-based transaction:
(a) The system 100, 200 requires the user 32 to transmit to the system 100, 200, images of the un-indorsed (e.g., unsigned) and unaltered, original version of the instrument 14.
(b) After the user 32 has transmitted the images required by step (a), the system 100, 200 requires the user 32 to transmit to the system 100, 200, images of the indorsed (signed) and altered version of the physical form of the instrument 14.

Step (a) helps to prove that the instrument 14 has not been previously cashed or deposited because it has not been indorsed or signed. In an embodiment, in step (b), the alteration must represent, indicate or cause a legal voiding of the instrument 14. Referring to FIG. 8, for example, the alteration includes, without limitation, physically marking or writing of the word, VOID on the front 38, drawing a line 271 on the front 38, poking or punching one or more holes 138, 140 in the instrument 14, or creating or forming a tear 144 in the instrument 14, applying a chemical liquid to the instrument 14, or using other suitable instrument destruction or instrument altering methods.

### 5. Electronic Configurations and Elements

In an embodiment, each system 100, 200 can be stored in a database. A processor (e.g., processor 101 or 205) can access such database over any suitable type of network, or the processor can access such database directly if the database and processor are parts of a single server unit. In addition, the user devices 102, the financial service provider devices 104 and the devices of fund source affiliates 16 can access such database over any suitable type of network. Depending upon the embodiment, the network can include one or more of the following: a wired network, a wireless network, a local area network (LAN), an extranet, an intranet, a wide area network (WAN) (including, but not limited to, the Internet), a virtual private network (VPN), an interconnected data path across which multiple devices may communicate, a peer-to-peer network, a telephone network, portions of a telecommunications network for sending data through a variety of different communication protocols, a Bluetooth® communication network, a radio frequency (RF) data communication network, an infrared (IR) data communication network, a satellite communication network or a cellular communication network for sending and receiving data through short messaging service (SMS), multimedia messaging service (MMS), hypertext transfer protocol (HTTP), direct data connection, Wireless Application Protocol (WAP), email or any other suitable message transfer service or format.

In an embodiment, such processor can include a data processor or a central processing unit (CPU). Each system 100, 200 can include one or more data storage devices, including, but not limited to, a hard drive with a spinning magnetic disk, a Solid-State Drive (SSD), a floppy disk, an optical disk (including, but not limited to, a CD or DVD), a Random Access Memory (RAM) device, a Read-Only Memory (ROM) device (including, but not limited to, programmable read-only memory (PROM), electrically erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

Referring to FIGS. 1 and 3, the users 32 and representatives of the payer's bank 168, fund source affiliate 16, financial service provider 22, and system implementor 18 can use or operate any suitable input/output (I/O) device to transmit inputs to the systems 100, 200 and to receive outputs from the systems 100, 200, including, but not limited to, a personal computer (PC) (including, but not limited to, a desktop PC, a laptop or a tablet), smart television, Internet-enabled TV, person digital assistant, smartphone, cellular phone or mobile communication device. In one embodiment, such I/O device has at least one input device (including, but not limited to, a touchscreen, a keyboard, a microphone, a sound sensor or a speech recognition device) and at least one output device (including, but not limited to, a speaker, a display screen, a monitor or an LCD).

In an embodiment, the computer-readable instructions, algorithms and logic of each system 100, 200 are implemented with any suitable programming or scripting language, including, but not limited to, C, C++, Java, COBOL, assembler, PERL, Visual Basic, SQL Stored Procedures or Extensible Markup Language (XML). Each system 100, 200 can be implemented with any suitable combination of data structures, objects, processes, routines or other programming elements.

In an embodiment, the interfaces of the systems 100, 200 can be a Graphical User Interfaces (GUIs) structured based on a suitable programming language. Each GUI can include, in an embodiment, multiple windows, pull-down menus, buttons, scroll bars, iconic images, wizards, the mouse symbol or pointer, and other suitable graphical elements. In an embodiment, the GUI incorporates multimedia, including, but not limited to, sound, voice, motion video and virtual reality interfaces to generate outputs of each system 100, 200.

In an embodiment, the memory devices and data storage devices described above can be non-transitory mediums that store or participate in providing instructions to a processor for execution. Such non-transitory mediums can take different forms, including, but not limited to, non-volatile media and volatile media. Non-volatile media can include, for example, optical or magnetic disks, flash drives, and any of the storage devices in any computer. Volatile media can include dynamic memory, such as main memory of a computer. Forms of non-transitory computer-readable media therefore include, for example, a floppy disk, flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read programming code and/or data. Many of these forms of computer readable media may be involved in carrying one or more sequences of one or more instructions to a processor for execution. In contrast with non-transitory mediums, transitory physical transmission media can include coaxial cables, copper wire and fiber optics, including the wires that comprise a bus within a computer system, a carrier wave transporting data or instructions, and cables or links transporting such a carrier wave. Carrier-wave transmission media can take the form of electric or electromagnetic signals, or acoustic or light waves such as those generated during RF and IR data communications.

It should be appreciated that at least some of the subject matter disclosed herein includes or involves a plurality of steps or procedures. In an embodiment, some of the steps or procedures occur automatically as controlled by a processor or electrical controller. In another embodiment, some of the steps or procedures occur manually under the control of a human. In yet another embodiment, some of the steps or procedures occur semi-automatically as partially controlled by a processor or electrical controller and as partially controlled by a human.

As will be appreciated, aspects of the disclosed subject matter may be embodied as a system, method, or computer program product. Accordingly, aspects of the disclosed subject matter may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the disclosed subject matter may take the form of a computer program product embodied in one or more computer readable mediums having computer readable program code embodied thereon.

Aspects of the disclosed subject matter are described herein in terms of steps and functions with reference to flowchart illustrations and block diagrams of methods, apparatuses, systems and computer program products. It should be understood that each such step, function block of the flowchart illustrations and block diagrams, and combinations thereof, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create results and output for implementing the functions described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the functions described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions described herein.

In an embodiment, each system 100, 200 provides a plurality of advantageous, technical effects. For example, in an embodiment: (a) each such system optically analyzes images of instruments 14 to decline instruments 14 which have been previously indorsed, signed or altered; (b) each such system mergers biometric imagery into the image of a back of an instrument 14, resulting in a single collective back image of the instrument 14; (c) each such system performs a multi-layer, multi-prong or tiered security test or condition set having multiple pass/fail points for progressing through instrument-based transactions; and (d) each such system performs an X-Y grid-based, optical analysis of the images of the physical forms of the instruments 14 to determine whether the instruments 14 have one or more holes or tears which pass entirely through the physical form or bodies of the instruments 14 for voiding purposes.

### 6. Instrument Voiding Device

In an embodiment, the systems 100, 200 each include an instrument voiding apparatus or device, including, without limitation, an instrument destruction tool incorporated into a keychain or a credit-card sized instrument destruction tool. Depending upon the embodiment, the instrument voiding device can create a hole, a tear, imprint or cutout pattern in the central area of the physical form of the instrument 14 or along any other portion of the instrument 14.

In an embodiment, as described above, the financial service provider 22 assists the user 32 in establishing a financial account 34, such as one linked to a payment card or loadable card. In such embodiment, such card is formed with a unique imprint, such as a raised or protruding code (e.g., numbers and/or letters) with pointy tops. In such embodiment, the systems 100, 300 each require the user 32 to press the protruding code onto the physical form of the instrument 14 to alter the instrument 14 by creating cuts, holes or an imprint with the protruding code.

Referring to FIGS. 25-29, in an embodiment, each system 100, 200 includes, or is used in conjunction with, an instrument voiding device 400. Depending upon the embodiment, the instrument voiding device 400 includes, or is incorporated into, a key, key fob, keychain accessory, keychain utility device, remote control device, door access device, door control device, transaction device or point of purchase device.

In the embodiment illustrated in FIGS. 25-29, the instrument voiding device 400 is operable to void instruments 14 and perform other utility functions. Instrument voiding device 400 includes a body 402 and an arm 404 moveably coupled to the body 402. The body 402 includes: (a) a fastener wall 406 defining a pass-through passage or opening 408 configured to receive a fastener, including, but not limited to, a key ring; (b) a payment input member, payment button or payment activator 410, including, but not limited to, a biometric reader or biometric sensor, such as a fingerprint reader; (c) a die tool or die 412; (d) an instrument aligner, stopper or instrument guide 414; and (d) a controller 416 housed within the body 202. The arm 404 includes: (a) a living hinge or other suitable hinge 418; (b) an underside 420; and (c) a stamper, former, poker or punch 422 coupled to the underside 420.

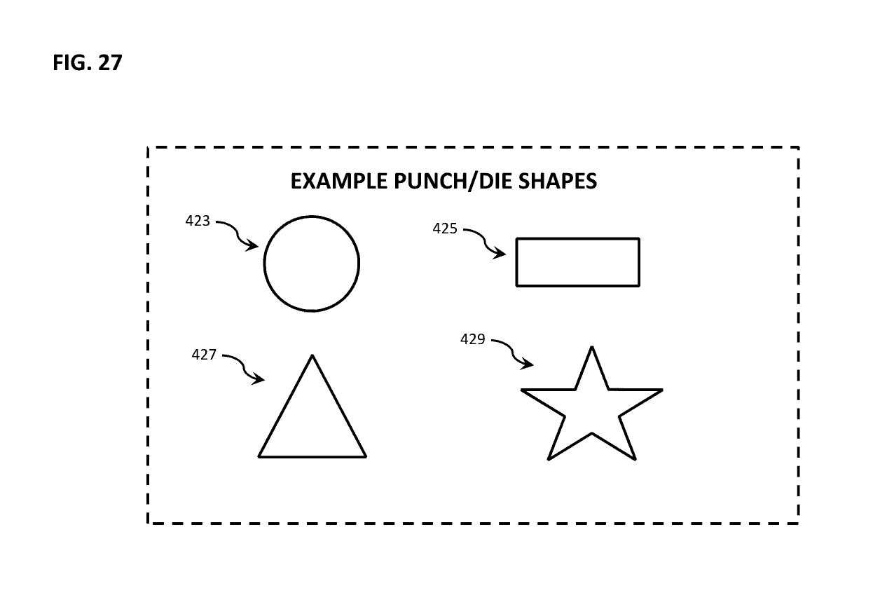

The die 412 and punch 422 have compatible shapes. For example, as illustrated in FIG. 27, the die 412 and punch 422 can both have: (a) a circular shape 423 for forming a circular hole in an instrument 14; (b) a rectangular shape 425 for forming a rectangular hole in an instrument 14; (c) a triangular shape 427 for forming a triangular hole in an instrument 14; (d) a star-shape 429 for forming a star-shaped hole in an instrument 14; or (e) any other suitable shape.

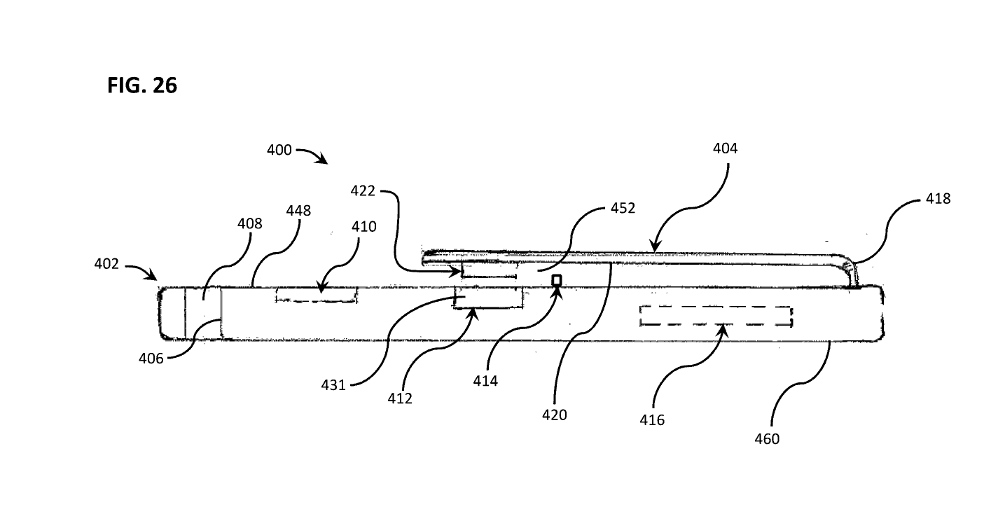

In the embodiment shown in FIGS. 25-26, the punch 422 has a smaller perimeter than the perimeter of the die 412. This enables the punch 422 to be pushed into the die cavity 431 (FIG. 26) defined by the die 412. It should be appreciated, however, that in other embodiments, the body 402 can include the punch, and the arm 404 can include the die that cooperates with such punch. In another embodiment, the instrument voiding device 400 does not include a die or die cavity. Rather, the body 402 includes a compliant, soft or depressible surface, such as a suitable rubber, foam or polymer surface. In such embodiment, the punch 412 is compressed onto such surface to punch or cut a hole into an instrument 14.

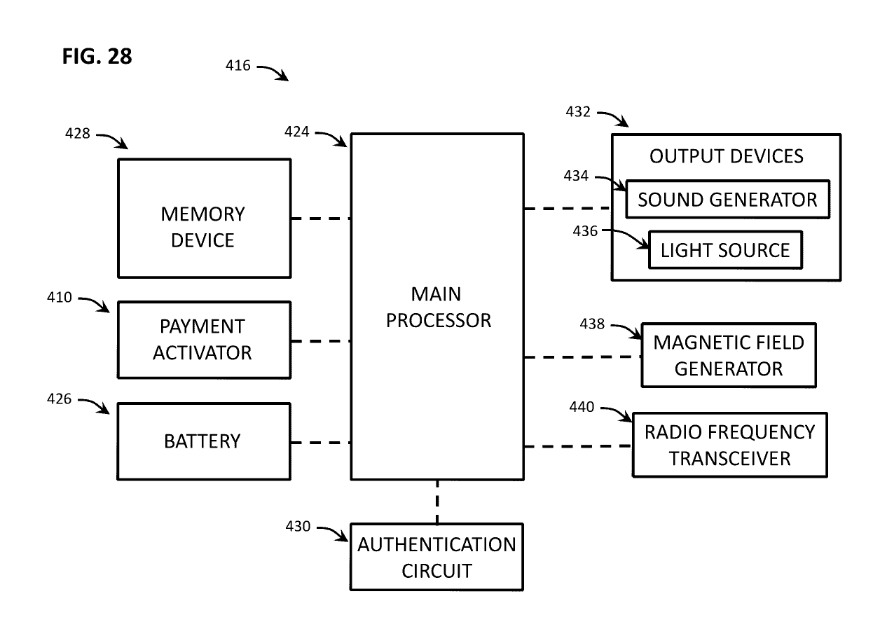

Referring to FIG. 28, the controller 416, in an embodiment, includes: (a) a main processor 424 operatively coupled to a power source or battery 426, a memory device 428 and an authentication circuit 430, such as an integrated circuit operable according to the EMV technical standard for smart payment cards. Also, the controller 416 includes a plurality of output devices 432, including, but not limited to, a speaker or sound generator 434 and a light source 436, such as a light emitting diode (LED) or flashlight. In addition, the controller 416 includes: (a) an antenna, electromagnetic induction device or high frequency, radio-frequency (RF) transceiver 438; and (b) another electromagnetic device, antenna or RF transceiver 440.

In an embodiment, the high frequency RF transceiver 438 is configured to generate magnetic fields or RF signals to operate at or within a near field communication (NFC) level or range, including, but not limited to, 13.56 MHz frequency. In such embodiment, the RE transceiver 440 is configured generate magnetic fields or RF signals according to the Bluetooth® protocol, which, for example, can include the generation of RE signals which occupy a section of the 2.4 GHz ISM band that is 83 MHz-wide. In another embodiment not illustrated, the controller 416 includes a single antenna or transceiver which performs the functions of the high frequency RF transceiver 438 and the RF transceiver 440.

The memory device 428 stores data and instructions executable by the processor 424 and circuit 430 to manage point-of-sale transactions and the functionality of the payment activator 410, output devices 432, high frequency RF transceiver 438 and RF transceiver 440. Depending upon the embodiment, the memory device 428 can include read only memory (ROM), random access memory (RAM), or a combination thereof.

Referring to FIGS. 1 and 25, in an embodiment, the instrument voiding device 400 serves the dual purpose of a payment card and a mechanical instrument destroyer. In operation of one example, the financial service provider 22 issues an instrument voiding device 400 to a user 32 while the user 32 visits the brick-and-mortar facility of the financial service provider 22. In this visit, the financial service provider 22 activates such instrument voiding device 400, establishing a unique financial account 34 associated with such instrument voiding device 400. As described further below, the user 32 can use such instrument voiding device 400 as an instrument voider and also as a payment card or financial account key for purchasing products and services.

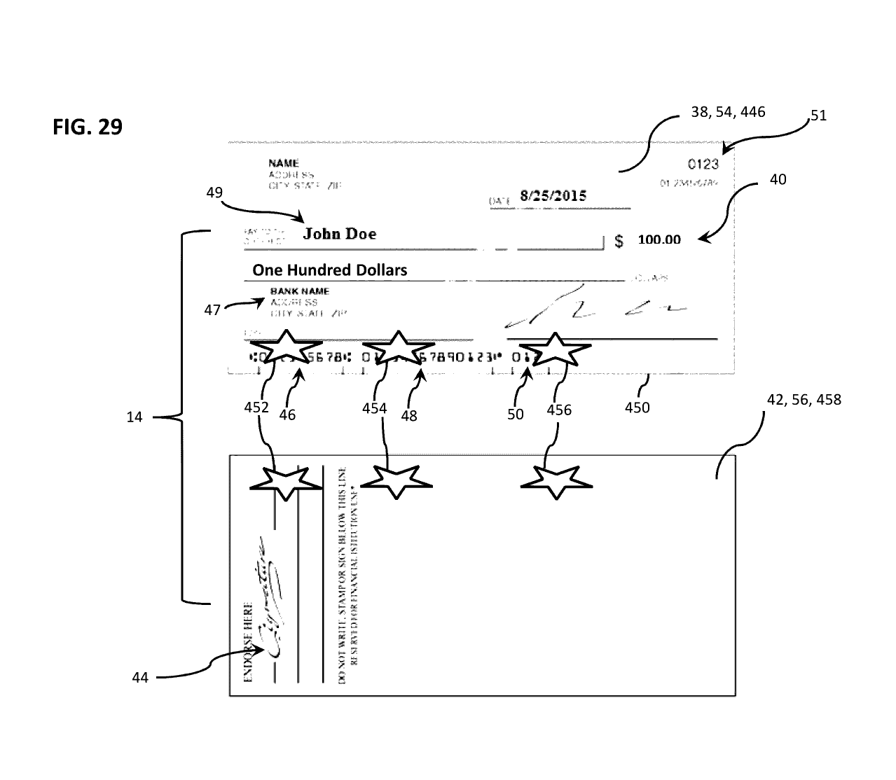

The user 32 can insert a key ring, chain loop or other fastener through the fastening hole 408. For example, this can enable the user 32 to secure the instrument voiding device 400 to his/her vehicle key chain. Referring to FIG. 29, the user 32 may desire to remotely cash or deposit an instrument 14 using one of the systems 100, 200 described above. Before the financial service provider 22 electronically provides final approval of the instrument 14, as described above, the user 32 can orient the instrument 14 with the instrument front 38 facing up so that the instrument 14 lies in a plane parallel with the face 248 (FIG. 25) of the body 202 of the instrument voiding device 400. Next, the user 32 inserts the edge 450 (FIG. 29) of the instrument 14 into the slot 452 (FIG. 26). The user 32 continues inserting the instrument 14 until the edge 450 abuts, and is flush with, the instrument guide 414.

The user 32 then uses the instrument voiding device 400 to void the instrument 14 according to the system's instructions, as described above. Depending upon the instructions, the user 32 may be required to perform one or any suitable combination of the following steps:
(a) Step A: Slide the instrument 442 until the routing number 46 is underneath the punch 422, and then press the arm 404 downward until the punch 422 enters the die cavity 431 and forms a voiding hole 452 in the instrument 14, removing some or all of the routing numerals, as illustrated in FIG. 29.
(b) Step B: Slide the instrument 14 until the bank account number 48 is underneath the punch 422, and then press the arm 404 downward until the punch 422 enters the die cavity 431 and forms a voiding hole 454 in the instrument 14, removing some or all of the bank account numerals, as illustrated in FIG. 29.
(c) Step C: Slide the instrument 442 until the instrument number 50 is underneath the punch 422, and then press the arm 404 downward until the punch 422 enters the die cavity 431 and forms a voiding hole 456 in the instrument 14, removing some or all of the instrument numerals, as illustrated in FIG. 29.

The one or more voiding holes 452, 454 and 456 are visible from the instrument front 38 and from the instrument back 42. After forming the one or more holes 452, 454 and 456, the user 32 uses his/her mobile user device 102 to record or take photographs of the altered, voided instrument front 446 and the altered, voided instrument back 458. As described above, the system 100, 200 and financial service provider 22 analyze the photograph images to confirm the presence of the one or more voiding holes 452, 454 and 456. In an embodiment, only after such confirmation does the system 100, 200 or financial service provider 22 enable the user 32 to cash or deposit the instrument 14.

In an embodiment, when the instrument 14 is cashed, the fund source affiliate 16 deposits funds (e.g., net amount) into the user's financial account 34 associated with the instrument voiding device 400. The user can then shop at a grocery store, for example, and use the instrument voiding device 400 at the cash register or point-of-sale to purchase products.

In an embodiment, the payment activator 410 includes a biometric reader or biometric sensor. In such embodiment, the payment activator 410 operates as a biometric lock, initiating a remote control mode, door unlock mode, payment mode, action mode, transaction mode or utility mode in response to the user's submission of his/her biometric data to the payment activator 410. For example, the user can initiate either such mode by holding his/her finger, face or eye over the payment activator 410 or by speaking into the payment activator 410.

In an embodiment, the instrument voiding device 400 is operable in the NFC mode. For an extra measure of security, the user must press or provide biometric input to the payment activator 410 before any payment code or payment signal can be received from the instrument voiding device 400. Once the user 32 presses or biometrically activates the payment activator 410, the processor 424 enables the high frequency RF transceiver 438 to generate a magnetic field associated with the user's payment code. The processor 424 enables such magnetic field to be generated during a designated payment period, such as thirty seconds. After the payment period expires, the processor 424 blocks such magnetic field or otherwise disables the high frequency RF transceiver 438, This security feature reduces the likelihood that a wrongdoer will be able to electronically pull the user's payment code by bringing a mobile NFC reader close to the device 400, unbeknownst to the user.

During the payment period, the user can hold the instrument voiding device 400 close to, but not in physical contact with, a point-of-sale NFC reader. The high frequency RF transceiver 438 generates an RF signal associated with the user's payment code. Like a credit card swipe, when the NFC reader receives such code, the cashier receives the payment from the user.

In one embodiment, the instrument voiding device 400 is operable in an EMV mode. At the point-of-sale, the user can interface the instrument voiding device 400 with a point-of-sale chip reader. Depending upon the embodiment, the authentication chip or circuit 430 can perform a contact or contactless interface with the point-of-sale chip reader. In operation, the RF transceiver 440 generates an RF signal associated with the user's payment code. Like a credit card swipe, when the point-of-sale chip reader receives such signal, the cashier receives the payment from the user.

In an embodiment, the instrument voiding device 400 has a finder or locating function to assist users who have lost or misplaced their instrument voiding devices 400. The user interface logic 204 (FIG. 11) has a finder interface for mobile devices 102 having Bluetooth® transceivers or other suitable RF transceivers. When the user submits a find input, the user's mobile user device 102 transmits a wireless find signal to the RF transceiver 440 of the instrument voiding device 400. The user interface logic 204 then displays a map to assist the user with finding the instrument voiding device 400. Depending upon the embodiment, the instrument voiding device 400 can incorporate a GPS module which cooperates with the GPS function of the user's mobile device 102 to assist with locating the instrument voiding device 400.

In an embodiment, the processor 424 causes the sound generator 434 to output a periodic beep or chirp sound when the user submits a find input through the system 100, 200 or through an Internet access device.

In an embodiment, the processor 424 causes the light source to produce light when the user presses a light switch or light button (not shown) attached to the body 402 of the instrument voiding device 400. In such embodiment, the user can use the instrument voiding device 400 as a flashlight. In an embodiment, the bottom 460 (FIG. 26) of the instrument voiding device 400 has or incorporates a magnet. Such magnet enables the user to magnetically attach the instrument voiding device 400 to a metal object, such as a refrigerator.

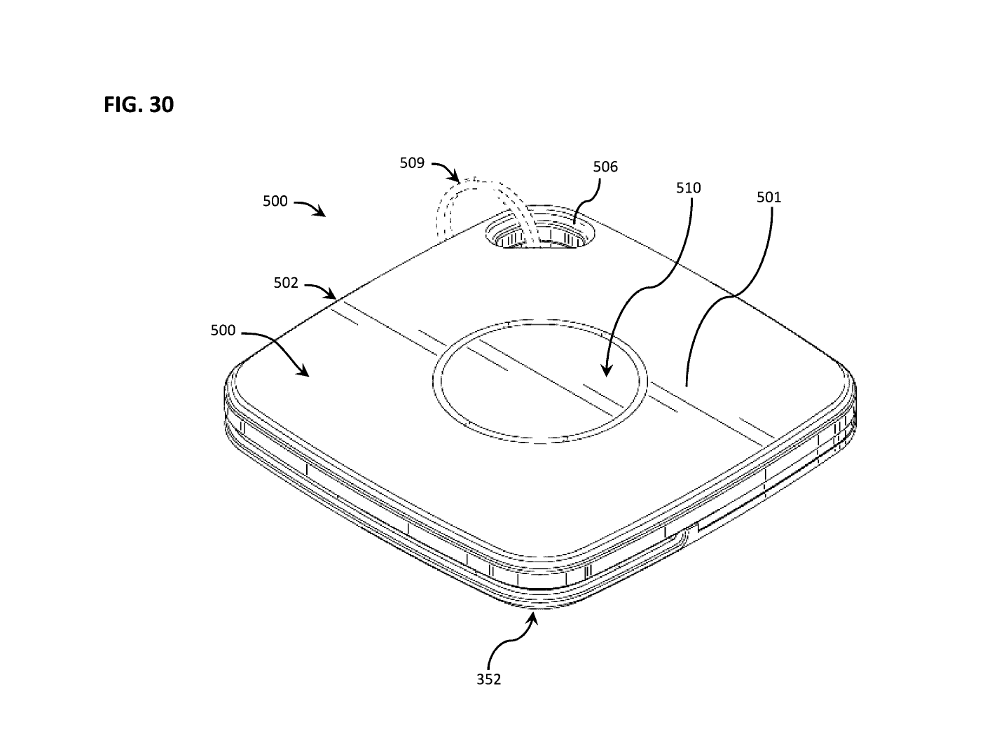

In an embodiment illustrated in FIGS. 30-33, the instrument voiding device 500 includes all of the structure, functionality and elements of instrument voiding device 400. Instrument voiding device 500 includes a body 502 and an arm 504 moveably coupled to the body 502. The body 502 includes: (a) a fastener wall 506 defining a pass-through passage or opening 508 configured to receive a fastener, including, but not limited to, a key ring 509; (b) a biometric payment input member, payment button or payment activator 510; (c) a die tool or die 512; (c) an instrument aligner, stopper or instrument guide 514; (d) a controller 516 housed within the body 502; and (e) a battery 517 operatively coupled to the controller 516 and payment activator 510.

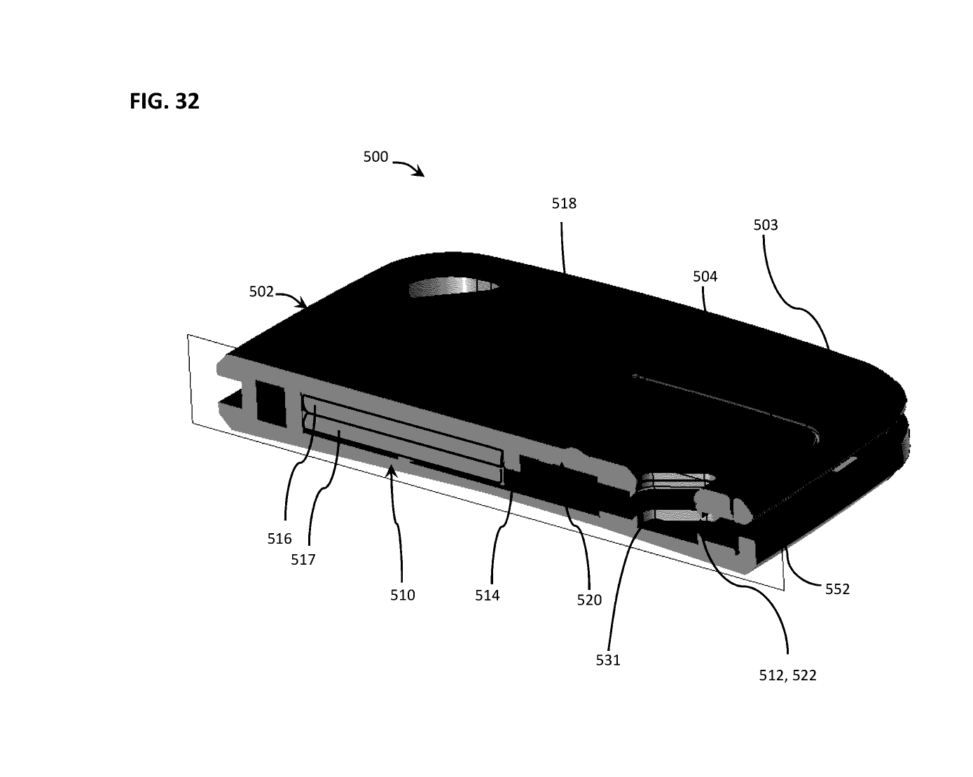

The arm 504 includes: (a) a living hinge or other suitable hinge 518; and (b) an interior surface 520. The interior surface 520 of the arm 504 is coupled to a stamper, former, poker or punch 522. The die 512 defines a die cavity 531 (FIG. 32). The body 502 defines a mouth or slot 552 configured to receive the physical form of instrument 14.

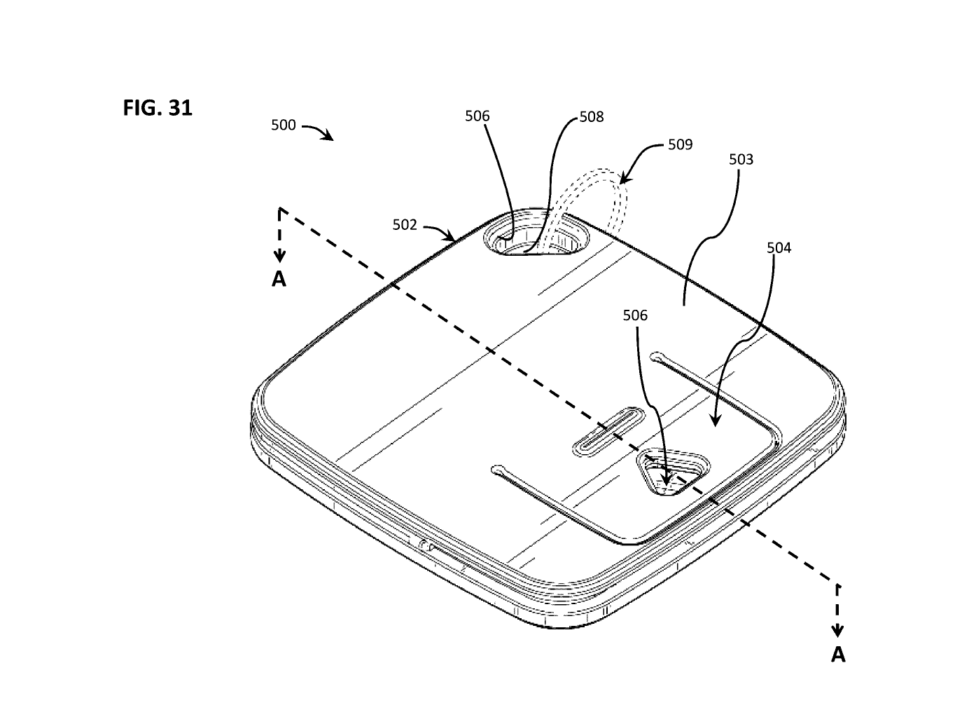

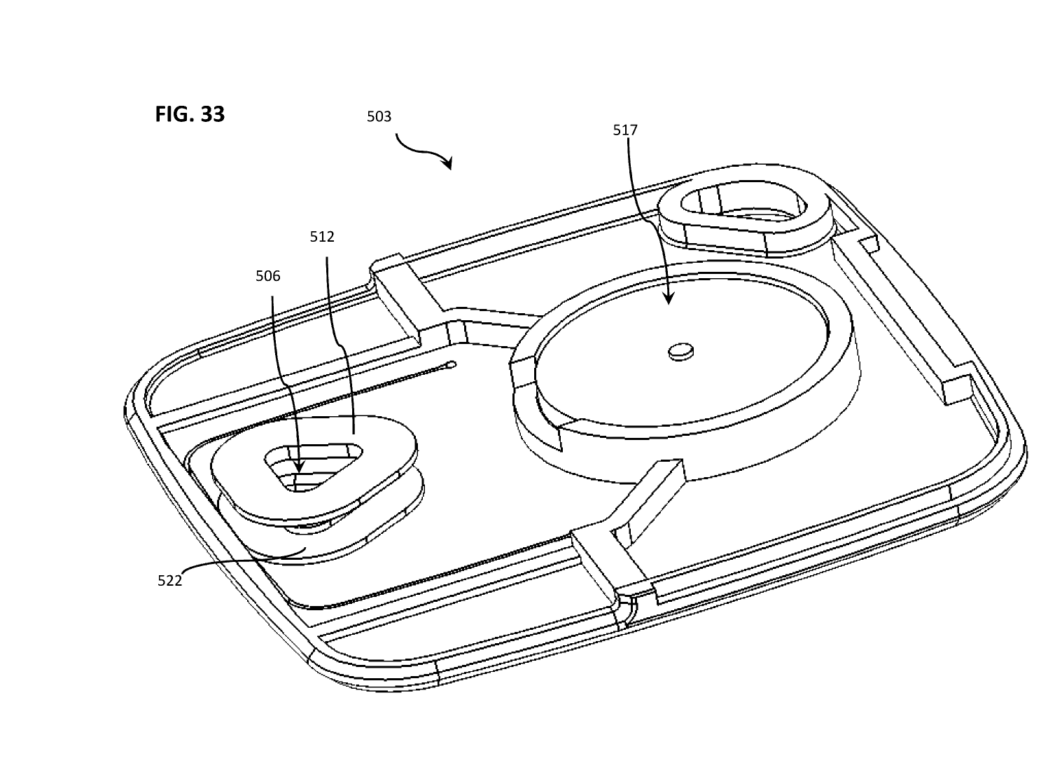

As illustrated in FIGS. 30-32, in the illustrated embodiment, the instrument voiding device 500 has a top half or top portion 501 (FIG. 30) and a bottom half or bottom portion 503 (FIGS. 31-33) which are coupled to each other through a press-fit connection, snap-fit connection, friction-fit connection or suitable bolts, screws or other fasteners. The arm 504 defines an instrument view opening or window 506 as illustrated in FIGS. 31 and 33. The instrument view opening or window 506 enables the user to view the instrument 14 as it is inserted into the mouth 552. This assists the user in properly placing the instrument 14 for creating a hole in the desired location on the instrument 14.

### 7. Personal Action Device

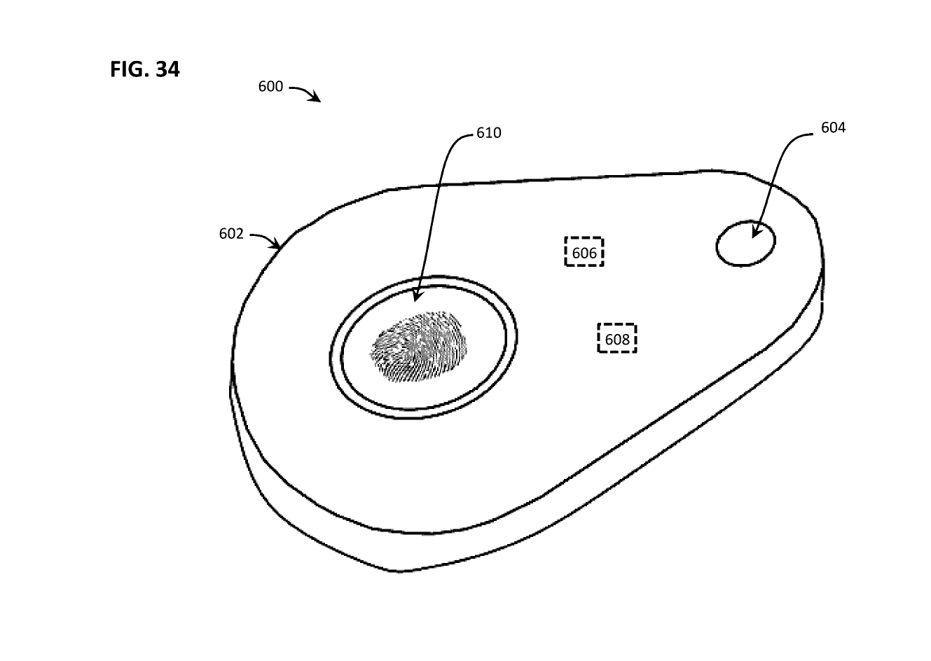

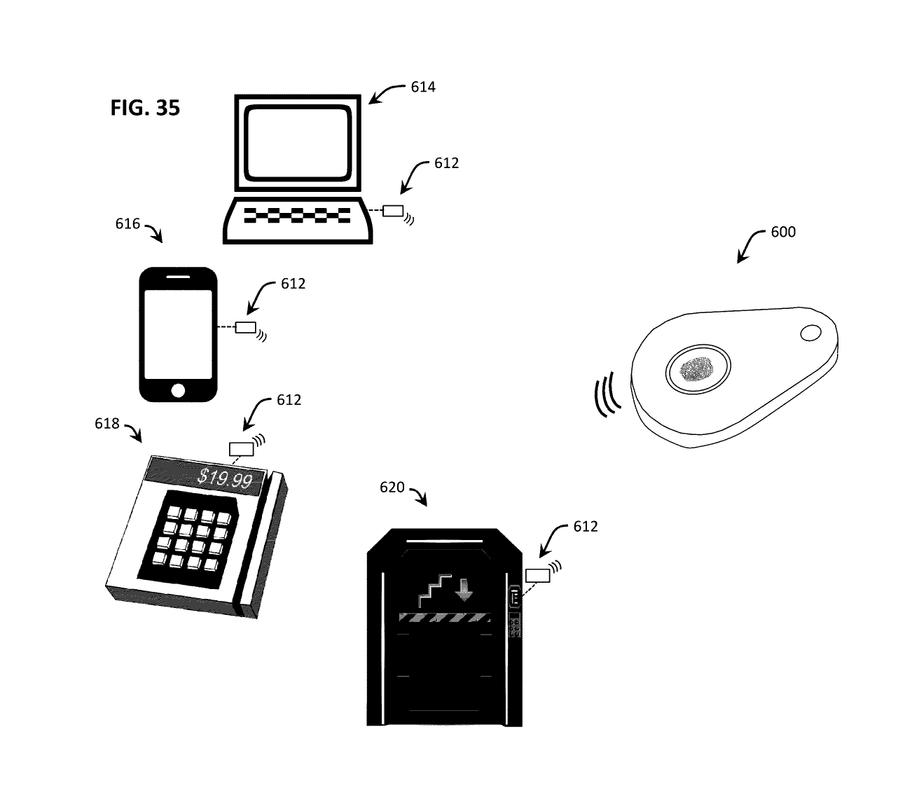

In an embodiment illustrated in FIGS. 34-35, the personal action device 600 includes, or is incorporated into, a key, key fob, keychain accessory, keychain utility device, remote control device, door access device, door control device, transaction device, point of purchase device or other personal utility device. In an embodiment, the personal action device 600 includes all of the structure, functionality and elements of instrument voiding device 400 except for those elements specifically related to instrument 14. For example, the personal action device 600 does not include any moving parts or arm 404, slot 452, die 412, guide 414 or punch 422 described above. In such embodiment, the personal action device 600 is operable for utility functions unrelated to instruments 14, including, but not limited to: (a) performing electronic, wireless payments drawn from the user's financial accounts (e.g., credit card, Visa® card, MasterCard®, reloadable payment card issued by a bank or other fund source sometimes referred to as a prepaid card, debit card, bank account, checking account, savings account, money market account, cash account, electronic wallet, electronic purse, PayPal® account, Google® Wallet account, Apple Pay® account or any other suitable online, wireless or Internet-accessible financial account for holding money or digital currency); (b) unlocking doors of vehicles, buildings or other structures; (c) verifying personal identity for passing through checkpoints, performing personal transactions which require identity verification, security clearance or other authorization confirmation; and (d) tracking activities of individuals holding or carrying personal action devices 600.

In an embodiment, the personal action device 600 includes: (a) a relatively thin body 602 defining a fastener opening 604 configured to receive a fastener or coupler, such as a key ring or keychain (not shown); (b) a battery 606 housed within the body 602; (e) circuitry or electronic assembly 608 housed within the body 602 and operatively coupled to the battery 606; and (d) a biometric activator, biometric gateway or biometric lock 610 operatively coupled to the electronic assembly 608.

The electronic assembly 608, in an embodiment, includes the controller 416 (FIG. 28) without the battery 426. In such embodiment, the high frequency RF transceiver 438 or radio frequency transceiver 440 is operable to generate a wireless NFC signal to wirelessly communicate with an NFC-compliant or Bluetooth®-compliant antenna or transceiver 612 of another device, such as devices 614, 616, 618, 620 (FIG. 35). In an embodiment, the high frequency RF transceiver 438 is configured to generate RF signals for NFC through. In another embodiment, the RF transceiver 440 is configured to generate RF signals through a Bluetooth® communication network or otherwise conforming to the Bluetooth® protocol.

In an embodiment, the memory device 428 stores personal identification data. Such data is unique to the particular user to whom the personal action device 600 was issued. In an embodiment, such data includes a biometric signature or biometric data of such user. In an embodiment, the memory device 428 stores such biometric data in digital, binary or object code form.

In an embodiment, the biometric lock 610 has no moving parts and includes a biometric reader, biometric sensor, biometric detector, biometric scanner, light detector, photo sensor, optical reader, optical scanner, thumbprint reader, fingerprint reader, retina reader, face recognizer, microphone, voice recognizer, audio input device or any other suitable type of biometric input device. When the user interfaces a portion of his/her body with the biometric lock 610, the biometric lock 610 receives an image input or audio input. Next, the electronic assembly 608 converts the received input to input data in digital, binary or object code form. Then, the electronic assembly 608 compares such input data to the biometric data pre-stored in the memory device 428.

If the electronic assembly 608 determines a match, the electronic assembly 608 electronically unlocks the personal action device 600 and starts a utility mode. In the utility mode, the electronic assembly 608 performs a wireless function related to a device. For example, as illustrated in FIG. 35, each device 614, 616, 618, 620 includes a magnetic field generator or radio frequency transceiver 612 configured to generate RF signals for NFC through a Bluetooth® communication network or otherwise conforming to the Bluetooth® protocol. In an embodiment, each device 614, 616, 618, 620 houses the radio frequency transceiver 612 within the housing of such device. In another embodiment, each device 614, 616, 618, 620 has at least one data port, and the radio frequency transceiver 612 is removably plugged into or electrically coupled to such data port.

In the example shown, when the personal action device 600 is in the utility mode, it is operable to: (a) wirelessly communicate with the computer 614 through radio frequency transceiver 612; (b) wirelessly communicate with the smartphone 616 through radio frequency transceiver 612; (c) wirelessly communicate with the point of sale payment receiver 618 through radio frequency transceiver 612; and (d) wirelessly communicate with the access control or lock module of door 620 through radio frequency transceiver 612.

In an example, a financial entity, such as a bank, issues a personal action device 600 to a customer. Also, the financial entity links to the personal action device 600, the customer's bank account, prepaid payment card account, ewallet or other financial account. When issuing the personal action device 600, the financial entity monitors, in-person, while the customer performs a biometric registration. In the biometric registration, the customer interfaces with the biometric lock 610 to store his/her unique biometric signature or biometric data in the personal action device 600.

In the example of a thumbprint biometric registration, the customer may conduct online purchases as follows: (a) operate the computer 614 or smartphone 616 to shop at a website and then place a product in an online shopping cart of the website; (b) hold his/her thumb over the biometric lock 610 for a designated period of time (e.g., five seconds), causing the electronic assembly 608 to unlock the personal action device 600 and start the utility mode; and (c) hold the personal action device 600 close to the computer 614 or smartphone 616, for example, to a position within six inches or three inches from the computer 614, smartphone 616 or the associated radio frequency transceiver 612 of such computer 614 or smartphone 616. At this point, the website automatically processes the purchase by charging the customer's financial account linked to his/her personal action device 600. After a designated period of time following the purchase (e.g., five seconds), the electronic assembly 608 automatically locks the personal action device 600, ending the utility mode. If a wrongdoer attempts to breach or communicate with the personal action device 600 when the personal action device is in the locked mode, not in the utility mode, the electronic assembly 608 remains inactive or asleep for utility purposes.

In another example, the customer may conduct in-store purchases at brick-and-mortar stores as follows: (a) scan a product at a cash register terminal in a store; (b) hold his/her thumb over the biometric lock 610 for a designated period of time (e.g., five seconds), causing the electronic assembly 608 to unlock the personal action device 600 and start the utility mode; and (c) hold the personal action device 600 close to the payment receiver 618, for example, to a position within six inches or three inches from the payment receiver 618 or the associated radio frequency transceiver 612 of such payment receiver 618. At this point, the store automatically processes the purchase by charging the customer's financial account linked to his/her personal action device 600. After a designated period of time following the purchase (e.g., five seconds), the electronic assembly 608 automatically locks the personal action device 600, ending the utility mode. If a wrongdoer attempts to breach or communicate with the personal action device 600 when the personal action device is in the locked mode, the electronic assembly 608 remains inactive or asleep for utility purposes.

In another example, a user operates the personal action device 600 to unlock a door 620 as follows: (a) hold his/her thumb over the biometric lock 610 for a designated period of time (e.g., five seconds), causing the electronic assembly 608 to unlock the personal action device 600 and start the utility mode; and (b) hold the personal action device 600 close to the lock or control panel of the door 620, for example, to a position within six inches or three inches from the such lock, control panel or the associated radio frequency transceiver 612. At this point, the door 620 unlocks. After a designated period of time following the unlocking of the door 620 (e.g., five seconds), the electronic assembly 608 automatically locks the personal action device 600, ending the utility mode. If a wrongdoer attempts to breach or communicate with the personal action device 600 when the personal action device is in the locked mode, the electronic assembly 608 remains inactive or asleep for utility purposes.

In an embodiment, the personal action device 600 has the shape and size of a credit card, suitable for insertion into a wallet. In such embodiment, the personal action device 600 includes a plurality of transaction interfaces, including: (a) the wireless radio frequency NFC interface operable by the electronic assembly 608; (b) the wireless radio frequency interface or electrical, contact-based interface operated by the authentication circuit 430, such as an integrated circuit operable according to the EMV technical standard for smart payment cards; and (c) a magnetic stripe interface configured for electrical, contact-based interface.

Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. A system comprising:
a data storage device configured to be operatively coupled to a network, the data storage device storing a plurality of computer-readable instructions which are executable by at least one processor to:
establish a user account associated with a user;
receive a request from a first network access device operatively coupled to the network, wherein the request relates to a financial instrument possessed by the user;
require submission of a first image representing a front of the financial instrument, the front image displaying a monetary amount;
require submission of a second image representing a back of the financial instrument, the back image displaying an indorsement by the user;
require submission of a third image representing biometric information related to the user;
receive data associated with the first, second and third images;
generate a fourth image comprising either one of: (a) the third image and the second image; or (b) the third image and the first image;
enable the request and the fourth image to be accessed by a device, wherein the device comprises either one of: (a) the at least one processor; or (b) a second network access device operatively coupled to the network;
receive a response from the device; and
depending upon the response, provide an approval notice to a fund source.

2. The system of claim 1, wherein:
the first network access device comprises a mobile communication device operated by the user; and
the second network access device comprises a computer operated by a financial service provider; and
the fund source comprises a financial database of a bank.

3. The system of claim 1, wherein:
the monetary amount comprises a gross amount;
the data storage device stores a plurality of computer-readable instructions which are executable by the at least one processor to operatively couple the user account to at least one financial account owned by the user, wherein the fund source is operable to transfer a net amount to the at least one financial account based at least in part on the approval notice; and
the net amount is less than the gross amount.

4. The system of claim 3, wherein the user account is associated with a payment card issued to the user.

5. The system of claim 1, wherein the indorsement comprises a signature of the user.

6. The system of claim 1, wherein the third image is selected from the group consisting of a photograph of the user, a photograph of a face of the user, an image of a biometric of the user, and a video displaying an action of the user.

7. The system of claim 1, wherein the fund source comprises a financial system, the financial system comprising: (a) a database of a financial entity; and (b) a data processor of the financial entity which is operatively coupled to the database.

8. The system of claim 1, wherein:
the fourth image comprises the third image and the second image; and
the step of generating the fourth image comprises merging together the third and second images.

9. The system of claim 1, wherein at least one of the first, second, third and fourth images comprises a representation of a structural alteration of a physical form of the financial instrument, wherein the representation represents at least one opening in the physical form of the financial instrument, the at least one opening being selected from the group consisting of: (a) a space between a plurality of torn edges of the physical form of the financial instrument; and (b) a hole extending through the physical form of the financial instrument.

10. A system comprising:
a data storage device configured to be operatively coupled to a network, the data storage device storing a plurality of computer-readable instructions which are executable by at least one processor to:
establish a user account associated with a user;
operatively couple the user account to a financial account of the user in response to a first input from a first network access device which is operatively coupled to the network;
receive a request from the first network access device, wherein the request is associated with a financial instrument, the financial instrument comprising a front and a back, the front showing a gross amount and an identity of the user;
receive a front image which represents the front, wherein the front image is generated by the first network access device;
receive a back image which represents the back, wherein the back image is generated by the first network access device, wherein the back image is generated by the first network access device;
receive a biometric image which represents a physical characteristic of the user, wherein the biometric image is generated by the first network access device;
generate a collective image comprising the back image and the biometric image;
enable a second network access device to access the front and collective images, wherein the second network access device is operatively coupled to the network;
receive a response from the second network access device, wherein the response comprises a decline of the request or an approval of the request;
if the decline is received, provide a decline notice to the first network access device; and
if the approval is received, provide an approval notice to a fund source, wherein the fund source is operable to transfer a net amount to the financial account, wherein the net amount is based, at least in part, on the gross amount.

11. The system of claim 10, wherein the data storage device stores a plurality of computer-readable instructions which are executable by the at least one processor to:
(a) receive back image data corresponding to the back image, the back image data comprising back image data code in object form;
(b) receive biometric data corresponding to the biometric image, the biometric data comprising biometric data code in object form; and
(c) merging the object form of the back image data code with the object form of the biometric data code to generate the collective image.

12. The system of claim 10, wherein the data storage device stores a plurality of computer-readable instructions which are executable by the at least one processor to apply an approval condition which requires the back image to exclude any indorsement.

13. The system of claim 12, wherein:
the approval condition comprises a first approval condition;
the data storage device stores a plurality of computer-readable instructions which are executable by the at least one processor to apply a second approval condition after the first approval condition has been satisfied;
the second approval condition requires a supplemental submission of the back image; and
the back image in the supplemental submission comprises an indorsement.

14. The system of claim 10, wherein the data storage device stores a plurality of computer-readable instructions which are executable by the at least one processor to apply an approval condition which requires the first network access device to transmit a void image representing the front or the back of the financial instrument.

15. The system of claim 14, wherein the void image comprises a representation of a structural alteration of a physical form of the financial instrument, wherein the structural alteration defines at least one opening in the physical form, the at least one opening being selected from the group consisting of: (a) a space between a plurality of torn edges of the physical form; and (b) a hole extending through the physical form.

16. The system of claim 10, wherein:
the first network access device comprises a mobile communication device operated by the user; and
the second network access device comprises a computer operated by a financial service provider; and
the fund source comprises a financial database of a bank.

17. A method of securing instrument-based transactions, the method comprising:
operating at least one processor which is operatively coupled to a data network, wherein the at least one processor is operable to control a system;
enabling a user to access the system using a first network access device;
operating the at least one processor to establish a user account for the user;
operating the at least one processor to operatively couple the user account to a financial account controlled by the user;
operating the at least one processor to receive a request from the first network access device to credit the financial account based on a financial instrument possessed by the user, wherein the financial instrument has a physical form;
operating the at least one processor to send a first notice displayable by the first network access device, wherein the first notice is related to a first requirement requiring the first network access device to send instrument data to the at least one processor, wherein the instrument data comprises:
a front image of a front of the financial instrument, wherein the front image displays an identity of the user and an amount payable;
a back image of a back of the financial instrument, wherein the back image displays an indorsement by the user; and
a biometric image derived from a human body of the user;
operating the at least one processor to enable a second network access device to access the instrument data;
operating the at least one processor to receive a first evaluation result from the second network access device, wherein the first evaluation result is based on a first evaluation of the instrument data;
depending upon the first evaluation result, operating the at least one processor to provide an approval notice displayable by the first network access device;
operating the at least one processor to provide a second notice to the first network access device, wherein the second notice relates to a second requirement, wherein the second requirement requires the first network access device to send voiding evidence to the at least one processor, wherein the voiding evidence comprises an image of a void indicator which is visible on at least one of the front and back sides of the physical form of the financial instrument;
operating the at least one processor to enable the second network access device to access the voiding evidence;
operating the at least one processor to receive a second evaluation result, wherein the second evaluation result is based on a second evaluation of the voiding evidence; and
depending upon the second evaluation, operating the at least one processor to provide an approval notice to a fund source.

18. The method of claim 17, comprising:
operatively coupling the at least one processor to at least one data storage device; and
storing a plurality computer-readable instructions in the at least one data storage device,
wherein the first and second evaluations are performed by at least one financial service provider,
wherein the fund source comprises a bank, and
wherein the bank credits the financial account with a monetary amount.

19. The method of claim 17, wherein the second requirement comprises requiring that the void indicator comprise a representation of a structural alteration of the physical form of the financial instrument, wherein the representation defines at least one opening in the physical form, the at least one opening being selected from the group consisting of: (a) a space between a plurality of torn edges of the physical form; and (b) a hole extending through the physical form.

20. The method of claim 17, wherein the second requirement is not reached if the first requirement is not satisfied.
